(19) United States
(12) Patent Application Publication
(10) Pub. No.: US 2026/0141516 A1
(43) Pub. Date: May 21, 2026

(54) PHYSICS-INFORMED AI-BASED SOFT-TISSUE SURGICAL HEALING ANALYSIS

(71) Applicant: Smartweave, Inc., Weston, MA (US)

(72) Inventors: Vidya Manian, Mayaguez (PR); Liz Teran Herrera, Mayaguez (PR); Rajeev Malhotra, Weston, MA (US)

(73) Assignee: Smartweave, Inc, Weston, MA (US)

(21) Appl. No.: 19/275,034

(22) Filed: Jul. 21, 2025

Related U.S. Application Data
(60) Provisional application No. 63/673,780, filed on Jul. 21, 2024.

(51) Int. Cl. G06T 7/00; G06T 7/13; G06V 10/25; G06V 10/764

(52) U.S. Cl. CPC G06T 7/0012; G06T 7/13; G06V 10/25; G06V 10/764; G06T 2207/20081; G06T 2207/20084; G06T 2207/30024

(57) ABSTRACT

Predicting a healing score of soft tissue post-surgical implants using physics informed predictive AI modeling.

### CLAIM TO PRIORITY

This application claims the benefit of U.S. Provisional Patent Application Ser. No. 63/673,780 filed Jul. 21, 2024, the entirety of which is incorporate herein by reference.

### BACKGROUND

### Technical Field

The present invention relates to medical imaging systems and artificial intelligence methods and systems described herein for post-surgical monitoring and prediction. More specifically, the invention pertains to physics-informed predictive AI modeling systems that generate healing scores for soft tissue evaluation following surgical implant procedures.

### Description of the Related Art

The assessment and prediction of tissue healing following surgical implant procedures presents significant technical and clinical challenges. Traditional methods for evaluating post-surgical outcomes rely heavily on subjective clinical assessments and lack standardized, objective metrics for quantifying healing progress. This creates difficulties in providing consistent therapeutic guidance and optimizing patient care protocols.

Current medical imaging analysis systems face substantial limitations in processing post-surgical tissue data. One of the primary technical obstacles is the scarcity of labeled medical imaging samples, which significantly hampers the development of effective machine learning models. Although Generative Adversarial Networks (GANs) have shown potential in improving image classification, there are few labeled samples due to the difficulty and high cost in collecting labeled samples. This limitation is present in the medical field, where obtaining properly labeled datasets requires extensive expert annotation and is associated with high costs.

Existing artificial intelligence approaches to medical image analysis typically employ conventional machine learning techniques that do not incorporate physics-based modeling principles. These systems fail to account for the underlying physical processes that govern tissue healing and implant integration. Furthermore, current methods do not adequately address the need for uncertainty quantification and representativeness measurements, which aid reliable clinical decision-making.

The medical field currently lacks standardized, quantitative metrics for assessing tissue healing progress following surgical implant procedures. Without objective healing metrics (aka scores), clinicians must rely on subjective assessments that can vary significantly between practitioners and institutions. This absence of standardized metrics impedes the development of evidence-based therapeutic protocols and limits the ability to provide consistent patient care.

While Graph Convolutional Networks (GCNs) have shown promise in various applications, their implementation in medical imaging for post-surgical assessment remains underdeveloped. Existing systems do not effectively utilize graph-based representations to model the complex spatial relationships between tissue regions and their healing characteristics. The construction of appropriate adjacency matrices that capture meaningful tissue connectivity patterns for healing assessment represents a significant technical gap in current methodologies.

Current post-surgical monitoring systems fail to effectively integrate diverse data sources that could enhance healing prediction accuracy. Patient-specific factors such as age, comorbidities, and health conditions are not systematically incorporated into predictive models. Additionally, supplemental data including chemistry, optics, genetics, and anatomical structures are not leveraged to improve healing score predictions.

The medical imaging field lacks comprehensive methods and systems described herein that combine generative AI techniques with physics-informed modeling for post-surgical tissue assessment. There is a particular need for systems that can generate synthetic training data to overcome the labeled data scarcity problem while simultaneously incorporating physical principles governing tissue healing processes. The development of such systems would enable more accurate and reliable prediction of healing outcomes, ultimately improving patient care and surgical planning.

These limitations in the prior art demonstrate the need for innovative methods and systems described herein that address the technical challenges of post-surgical tissue assessment through advanced AI methodologies, physics-informed modeling, and standardized healing score generation.

### SUMMARY

The present disclosure provides methods and systems for predicting changes in tissue post-surgery through the integration of artificial intelligence technologies, including without limitation, GAN-based training data generation, physics-informed modeling, and healing score prediction.

The methods and systems described herein may address a fundamental challenge in medical Artificial Intelligence (AI) by utilizing, for example, Wasserstein Generative Adversarial Networks (WGANs) to overcome scarcities of labeled medical imaging data. In example embodiments, a generator and discriminator network architecture, such as one or more GANs improve image classification with fewer labeled samples. A WGAN implementation may also employ a penalty term to prevent or deter vanishing or explosion gradients during training, enabling the generation of synthetic tissue samples that closely match real medical images.

The methods and systems described herein may integrate a GAN architecture with a blind deconvolution autoencoder that performs unsupervised pure pixel tissue image sampling, identifying undamaged or unaltered tissue samples for training purposes. This innovative combination may create a robust training dataset from limited labeled medical images, significantly enhancing learning capabilities.

The methods and systems described herein may incorporate physics-based principles into an AI modeling process through, for example, representativeness and uncertainty measurement techniques, and the like. The methods and systems described herein may implement weighted incremental dictionary learning (WI-DL). WI-DL may be combined with geometric simple linear iterative clustering (SLIC) applied to unlabeled image data using, for example an elliptic kernel.

A physics model may incorporate uncertainty measurement using entropy calculations of a function that represents the probability that sample x belongs to class j. Representativeness measurement may be achieved, for example through projecting samples to a Grassman manifold, enabling the system to discriminate among representative and uncertain samples. Such discrimination may facilitate enhanced training, that may include optimal training.

This physics-informed approach may ensure that AI predictions are grounded in underlying physical processes governing tissue healing and implant integration, rather, for example, than relying solely on pattern recognition.

The methods and systems described herein may generate standardized, quantitative healing scores through a Graph Convolutional Network (GCN) classifier or the like that processes non-Euclidean graph structures when handling complex medical image topologies. Tissue healing classes include at least four distinct categories: 1—not healing, 2—poor healing, 3—average healing, and 4—good healing.

In example embodiments, healing score prediction may integrate multiple data sources, such as patient attributes (e.g., time period for healing, patient age, comorbidities, health condition, and the like), optionally along with supplemental data representative of chemistry, optics, genetics, non-visible tissue, related anatomy including nerves, blood vessels, anatomical structures, and the like. The methods and systems described herein include near-seamless integration of at least three technologies into a unified system. These technologies include: (i) a training set of tissue images, prepared using the autoencoder architecture; (ii) a physics model that uses representativeness and uncertainty measurement techniques to process the training set; and (iii) a healing score predictive neural network. A goal of application of these technologies includes classifying surgery-patient implant sites and predicting changes over time.

The methods and systems described herein demonstrate exceptional performance with validation showing >90% average accuracy (typically 92%), >80% Kappa score (typically 83%), >90% F1-score (typically 93%), and at least 95% Recall in clinical testing. This integrated approach provides objective, standardized assessment of post-surgical healing that guides therapeutic direction, provides feedback to implant design and methods, and enables evidence-based clinical decision-making.

In example embodiments, the methods and systems described herein provide a significant advancement in medical AI by combining, for example, generative modeling, physics-informed learning, and predictive analytics into comprehensive methods and systems described herein that address needs in post-surgical monitoring and patient care optimization.

### BRIEF DESCRIPTION OF THE DRAWINGS

The features of the disclosed embodiments may become apparent from the following detailed description taken in conjunction with the accompanying drawings showing illustrative embodiments herein, in which:

FIG. 1 depicts a high-level system diagram showing the integration of training set generation, physics model, and predictive neural network components including data flow from input images through healing score output.

FIG. 2 depicts a detailed architecture showing a first neural network (autoencoder) and a second neural network (predictive) associated with training set generation and healing score prediction pathways.

FIG. 3 depicts a generator and discriminator network structure, Wasserstein distance calculation and gradient penalty implementation, and latent space to synthetic medical image generation process.

FIG. 4 depicts a blind deconvolution autoencoder structure including identification of undamaged/unaltered tissue samples and pixel-level processing for MRI images.

FIG. 5 depicts a process flow from raw tissue images to prepared training set including integration of autoencoder output with neural network training.

FIG. 6 depicts a surgical implant effects modeling framework for representativeness and uncertainty measurement techniques as integrated with a predictive neural network.

FIG. 7 depicts a weighted incremental dictionary learning process, such as SLIC clustering with elliptic kernel associated with representative vs. uncertain sample distinction methodology.

FIG. 8 depicts an entropy calculation visualization of a Grassman manifold projection for representativeness and associated weighted incremental dictionary learning.

FIG. 9 depicts a GCN layer structure with 64 units and ReLU activation, adjacency matrix construction from pixel relationships, and global average pooling and output layer configuration.

FIG. 10 depicts a pixel-to-node conversion process for edge relationship determination for medical images with or without spatial graph embedding generation.

FIG. 11 depicts a Four-category healing score output integrated with patient attributes (age, comorbidities, health condition) for time-based prediction capabilities.

FIG. 12 depicts supplemental data processing (e.g., chemistry, optics, genetics, anatomical structures) of/for large language model integration with medical anomaly-aware vocabulary for natural language generation for implant site descriptions.

FIG. 13 depicts a ten-fold cross-validation accuracy visualization of a performance metrics table comparing pre-surgery vs. post-surgery classification workflow.

FIG. 14 depicts post-surgical implant MRI image input processing of regions of interest identification and analysis for integration with bio-scaffold tissue implant applications.

FIG. 15 depicts tumor edge visualization capabilities for select anatomy detection implementation using AI services.

FIG. 16 depicts tumor tissue and scar tissue detection and malady score prediction with surgical recommendation generation.

FIG. 17 depicts an end-to-end process from image input to healing score output including integration of components of clinical decision support and therapeutic guidance pathway.

FIG. 18 depicts a cross-validation methodology, accuracy measurement and evaluation metrics, and refinement and improvement processes.

FIG. 19 depicts GAN-based generation of ROI samples from actual MRI images.

FIG. 20 depicts a physics-informed AI model to predict changes in soft tissue post-surgery

FIG. 21 depicts binary classification of brain tumor images pre- and post-surgery.

FIG. 22 depicts ten-fold cross-validation accuracies.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

### Definitions of Key Technical Terms

Healing Score—A healing score is a quantitative metric that classifies tissue healing progress into standardized categories. As variously described in the disclosure, the healing score may represent a degree of healing that may be classified into four distinct categories: 1—not healing, 2—poor healing, 3—average healing, and 4—good healing. The healing score may be generated by a predictive neural network that may include classifying images of the surgery-patient implant sites against a range of healing scores indicative of a degree of healing. The healing score may be further enhanced by incorporating patient or surgery attributes including one or more of time period for healing, patient age, comorbidities, and patient health condition.

Pure Pixel—A pure pixel refers to image pixels that represent undamaged or unaltered tissue samples as identified through the autoencoder architecture. In the context of a blind deconvolution autoencoder, pure pixels are distinguished from non-pure pixels that may have mixture constituents representing damaged or modified tissue samples.

Physics-Informed Modeling—Physics-informed modeling refers to the integration of physical principles, laws, and the like governing tissue healing and implant interactions into an artificial intelligence framework. Physics informed modeling of implant effects may include using representativeness and uncertainty measurements to predict changes in soft tissue post-surgery. The physics model processes additional physics measurements and integrates physical principles rather than relying solely on pattern recognition.

Autoencoder Architecture—An autoencoder architecture includes a neural network structure used for generating training sets of tissue regions of interest. In example embodiments, a neural network having an autoencoder architecture prepares training sets from tissue images. Further, the autoencoder architecture may be nonsymmetric and includes a blind deconvolution autoencoder that outputs pure tissue endmembers.

Representativeness and Uncertainty Measurement—Representativeness measurement may generally be based on projecting tissue samples to Grassman manifold to determine how well samples represent the underlying data distribution. Uncertainty measurement is calculated based on Entropy on a current prediction of a Graph Convolution Network (GCN) classifier using a formula based on the probability that the sample “x” belongs to the “jth” class. These measurements may be used in the physics model to distinguish among representative samples and uncertain samples.

Graph Convolutional Network (GCN)—A Graph Convolutional Network as used herein may be a neural network architecture that performs convolution operation similar to Convolutional Neural Networks (CNN) but on non-Euclidean graph structures, and hence can handle complex topologies. Herein, the GCN may serve as a classifier for predicting healing scores and may consist of a plurality of GCN layers each having a plurality of units and ReLU activation.

Weighted Incremental Dictionary Learning (WI-DL)—Weighted Incremental Dictionary Learning as used herein may embody an active learning paradigm applied to improve accuracy of the prediction of healing scores. WI-DL may be used herein to refine selection of most representative samples, and reject most uncertain samples for training the GCN

Wasserstein Generative Adversarial Network (WGAN)—A Wasserstein Generative Adversarial Network is a generative model consisting of a generator that generate samples from a latent space which are then used by a discriminator that compares their distance from labeled samples. The WGAN uses this distance for training and includes a penalty term that avoids vanishing or explosion gradients in training the GAN.

Regions of Interest (ROI)—Regions of Interest are specific tissue areas identified and extracted from medical images for analysis. These regions represent focused areas of tissue that are relevant for healing assessment and are processed through the various AI components of the system.

Malady Score—A malady score represents an impact on the healing score when the AI services detect problematic tissue conditions, such as tumor tissue or scar tissue. This score quantifies negative factors that may impede healing progress.

Medical Anomaly—Aware Vocabulary-A medical anomaly-aware vocabulary may be developed through large language model features and structures trained from the supplemental data and the images of the surgery-patient implant sites and sources of medical science and practice. This specialized vocabulary enables a large-language model neural network type of system to process images of the surgery-patient implant sites to facilitate a description of the implant sites with respect to the healing score.

### Detailed Disclosure of the Invention

### Overview

This document discloses a comprehensive method, system, and platform for predicting changes in tissue post-surgery. Predicting changes may be performed through one or more of targeted artificial intelligence methodologies, physics-informed modeling, or standardized healing score generation. In example embodiments, predicting changes may be performed through a platform that integrates at least these three techniques. Addressing critical challenges in post-surgical monitoring may include combining generative adversarial networks, autoencoder architectures, graph convolutional networks, and the like to provide objective, quantitative assessment of tissue healing progress.

### Core System Architecture

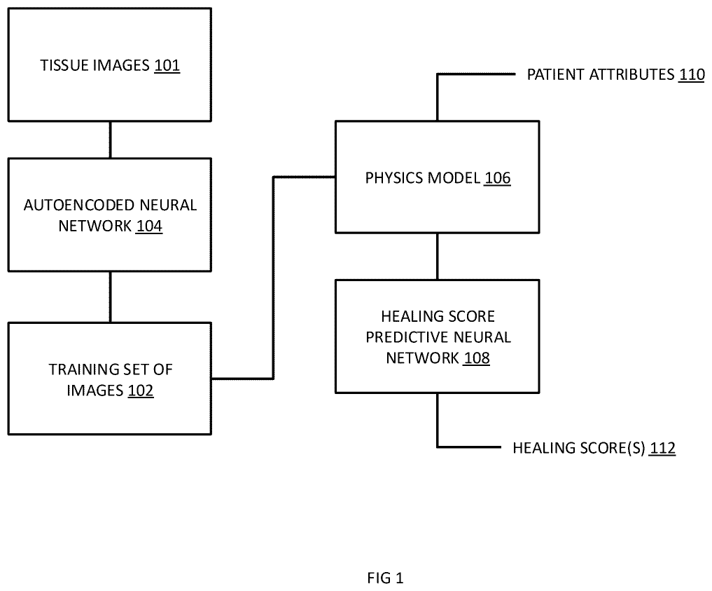

In example embodiments, the platform for predicting changes in tissue post-surgery may include three primary components, optionally integrated as illustrated in FIG. 1. The platform may be embodied as a system that includes a training set of images 102 of tissue regions of interest. This training set of images 102 may be prepared from a set of tissue images using a neural network having an autoencoder architecture 104. This autoencoder architecture 104 optionally performs blind deconvolution when generating the regions of interest. Regions of interest may define undamaged or unaltered tissue samples 412. Portions of the regions of interest may be defined by a set of pixels in an MRI image, enabling precise tissue characterization.

A physics model 106 of surgical implant effects may use representativeness and uncertainty measurement techniques 206 to facilitate predicting post-surgery changes to surgery-patient implant sites. This physics model 106 may include additional physics measurements 602 for enhanced tissue analysis as well as patient attributes 110, such as time period for healing, patient age, comorbidities, patient health condition, and the like.

A third core component includes a healing score predictive neural network 108. This predictive neural network may classify images of the surgery-patient implant sites against a range of healing scores 112 indicative of a degree of healing. The predictive neural network 108 may further predict changes over time of a healing score for a patient, providing dynamic assessment capabilities. Generative Adversarial Network Implementation

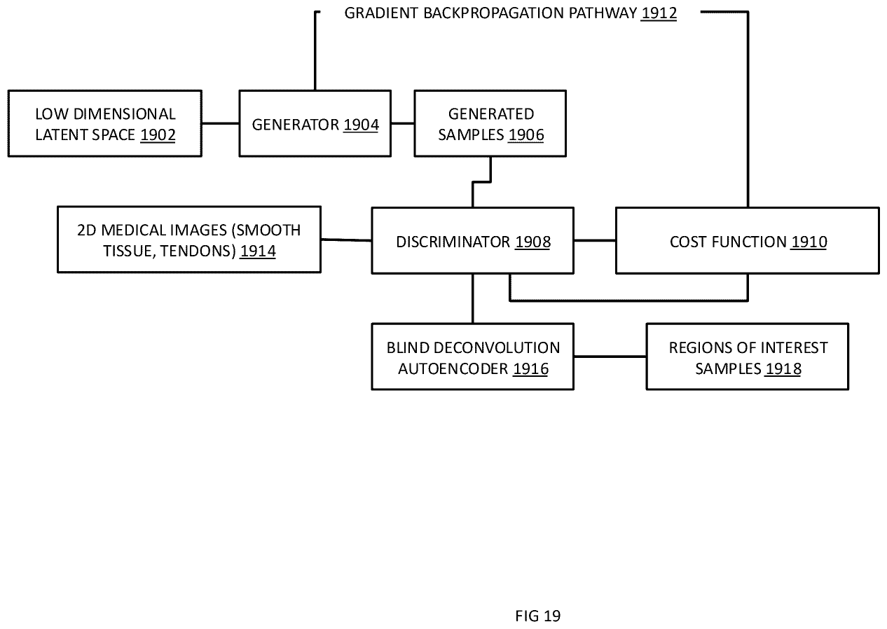

In example embodiments, Wasserstein Generative Adversarial Networks (WGANs) may be used for generating training sample regions of interest from soft tissue images. As shown in FIG. 19, the WGAN architecture consists of a generator network 1904 and discriminator network 1908 implemented as multilayer perceptron (MLP) networks. The generator 1904 produces samples from a low dimensional latent space 1902 which are then evaluated by the discriminator 1908 that compares their distance from labeled samples. The latent space 1902 consists of sparse representation of data points from original training data in a low dimensional space or could be composed of random Gaussian noise. The samples are generated more closely to the labeled samples at every iteration by a minmax algorithm that is then used by the discriminator network 1908 to improve the labeling of the images.

A workflow for the proposed scheme of WGAN for synthesis of tissue samples using the Wasserstein distance is shown in FIG. 19. A blind deconvolution autoencoder 1916 may be used for obtaining the pure pixels regions of interest from the bio-scaffold tissue images. Here, pure is defined as undamaged or unaltered tissue samples (pixels). A mathematical formula governing the GAN may be expressed as:

$$E ( G , D ) = \frac{1}{2} E \text{?} [ 1 - D ( x ) ] + E \text{?} [ D ( G ( z ) ) ] \qquad ( 1 )$$

$$\text{?} \text{indicates text missing or illegible when filed}$$

where Pt is the probability density function (pdf) of the original image, Pz is the pdf of the noise or latent space. E is the overall error generated by both generator and discriminator. The minmax training consists of training the generator network 1904 by maximizing the error; while training the discriminator network 1908 by minimizing the error given by

$${min}_{G} ( {max}_{D} \vert E ( D , G ) ) \qquad ( 2 )$$

The overall equation of the GAN is given by

$${min}_{G} {max}_{D} V ( D \text{?} G ) = \frac{1}{2} E \text{?} [ D ( x ) ] + E \text{?} [ D ( G ( z ) ) ] \qquad ( 3 )$$

$$\text{?} \text{indicates text missing or illegible when filed}$$

When the generator network 1904 produces the same pdf as the discriminator network 1908, there is near-perfect convergence. Kullback-Leibel divergence may be used for comparison of the density. A penalty term 308 may be added to the discriminator network 1908 loss function and is given by,

$$D \text{?} = E \text{?} [ D ( G ( z ) ) ] - E \text{?} [ D ( x ) ] + λE {\text{?} [ {\vert ∇ D ( x ) \vert}_{p} - 1 ]}^{2} \qquad ( 4 )$$

$$\text{?} \text{indicates text missing or illegible when filed}$$

### Autoencoder Architecture for Pure Pixel Extraction

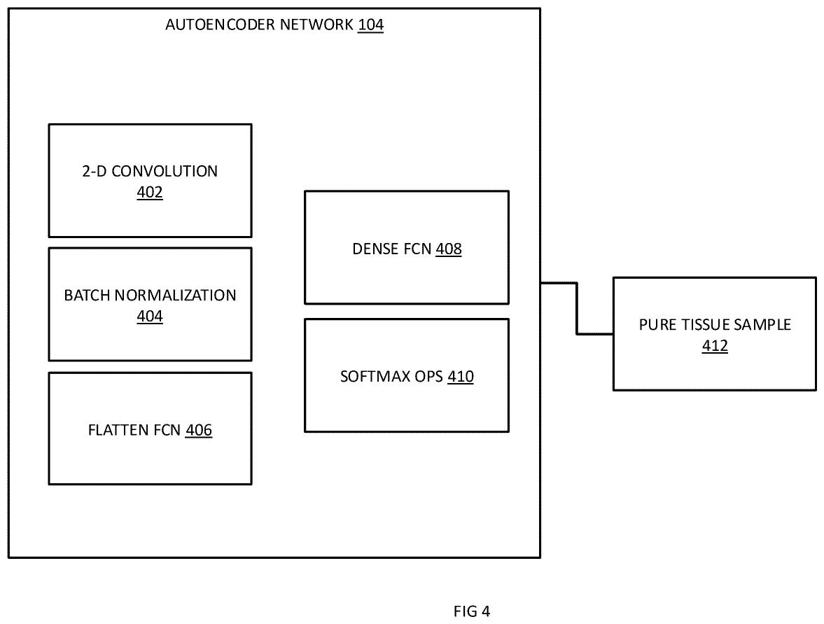

FIG. 4 depicts a blind deconvolution autoencoder 104 for obtaining pure pixel regions of interest from bio-scaffold tissue images, where “pure” is defined as undamaged or unaltered tissue samples. As detailed in FIG. 4, the autoencoder architecture 104 is nonsymmetric and consists of 2-dimensional convolutional operations 402, batch normalization 404, flatten 406, dense 408, and softmax operations 410. This nonsymmetric autoencoder outputs pure tissue endmembers and extracts fractional abundances of non-pure pixels that may contain mixture constituents representing damaged or modified tissue samples. The output of the autoencoder 104 serves as input to the subsequent stage 502 for unsupervised feature learning as a component of the active learning mechanism for healing score prediction.

### Physics-Informed Modeling and Active Learning

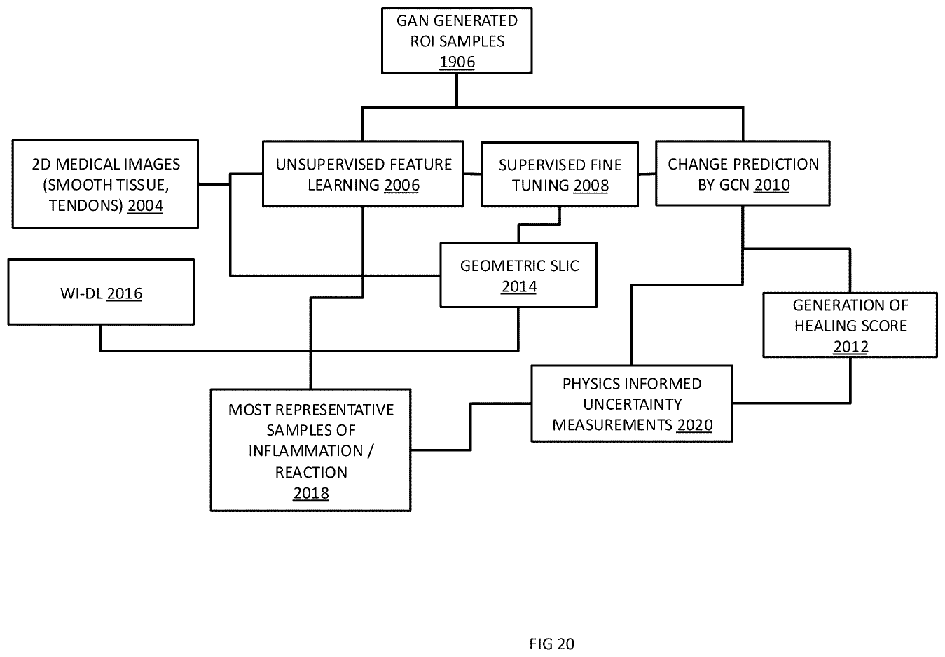

The platform implements physics-informed modeling of implant effects using representativeness and uncertainty measurements to predict changes in soft tissue post-surgery, as illustrated in FIG. 20. The system employs weighted incremental dictionary learning (WI-DL) 2016 to optimize the objective function and applies geometric simple linear iterative clustering (SLIC) 2014 to unlabeled image data using an elliptic kernel. This may be used by the supervised fine-tuning block 2008 for representativeness measurement 706 which may be based on projecting the samples to a Grassman manifold. Uncertainty measurement 708 may be based on Entropy on the current prediction of the Graph Convolution Network (GCN) classifier.

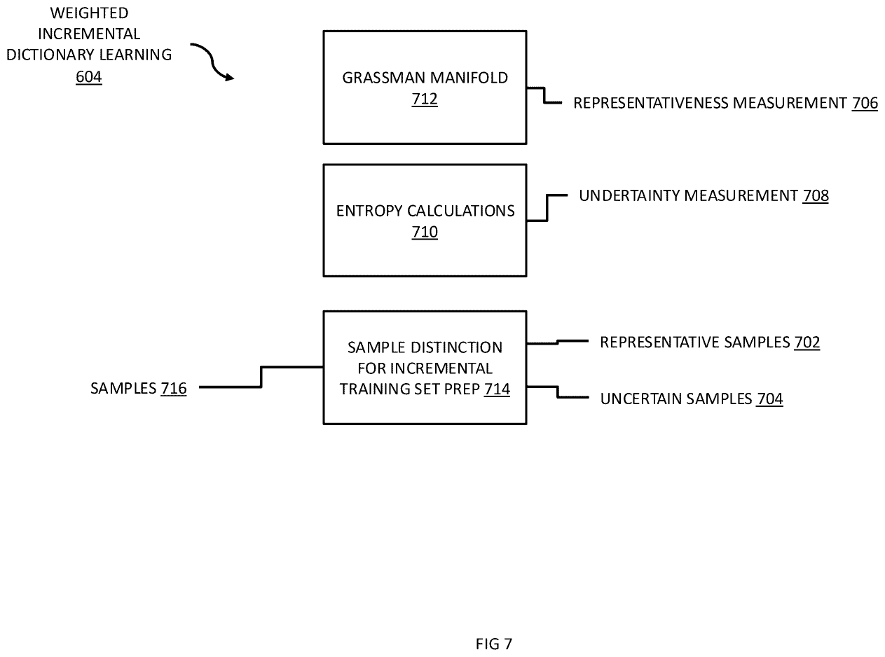

Referring to FIG. 7, active learning may be categorized into uncertainty-based, performance-based, and representativeness-based approaches. A representativeness measurement 706 may be based on projecting samples to a Grassman manifold, while uncertainty measurement 708 may utilize entropy calculations according to the formula

$$ϕ ( x ) = - \text{?} p ( y \text{?} \vert x ) log ( p ( y \text{?} \vert x ) ) \qquad ( 5 )$$

$$\text{?} \text{indicates text missing or illegible when filed}$$

where p(yⱼ|x) represents the probability that sample x belongs to the jth class.

The system distinguishes among representative samples 702 and uncertain samples 704 to prepare an incremental training set for improved healing score prediction accuracy. At every iteration, additional dictionary atoms 1004 selected by active learning train the Graph Convolutional Network much more efficiently in terms of representativeness 706 and uncertainty 708 than random sample selection.

### Graph Convolutional Network Architecture

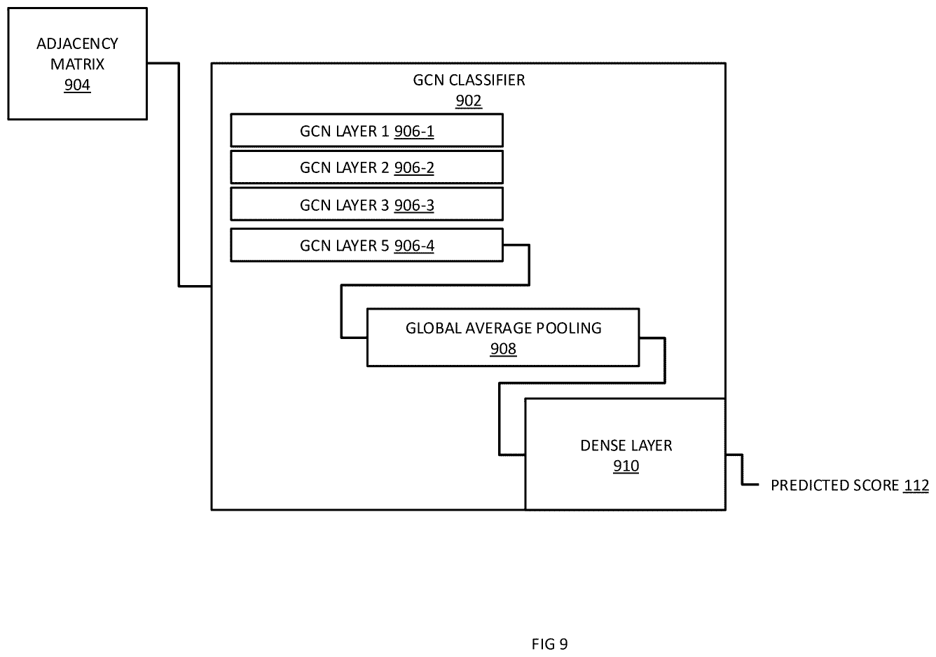

In example embodiments, the GCN outputs the healing scores of the soft tissue regions that received the implant, based on the uncertainty and representativeness actively learnt from the WGAN synthesized pure pixel images, and the additional physics information on the soft tissue. Referring to FIG. 9, the platform incorporates a Graph Convolutional Network (GCN) classifier 902 which relies upon a corresponding adjacency matrix 904 representing pixel (node) relationships as edges of an undirected graph. As shown in FIG. 9, the GCN architecture includes four GCN layers 906, each with 64 units and ReLU activation, that sequentially process graph data.

The GCN 902 performs convolution operations similar to Convolutional Neural Networks but on non-Euclidean graph structures, enabling it to handle complex topologies. A global average pooling layer 908 is applied to the output of the last GCN layer, followed by a dense layer 910 with a single output unit and sigmoid activation function for binary classification tasks.

The adjacency matrix 904 is constructed from graph embeddings 1002 of representativeness measurements 706, uncertainty measurements 708 from physician information, and existing images with pseudo soft tissue labels from the autoencoder 104. Dictionary atoms 1004 are obtained from the hidden layer of the GCN 902, which serves as feature learning and dimensionality reduction.

### Healing Score Classification System

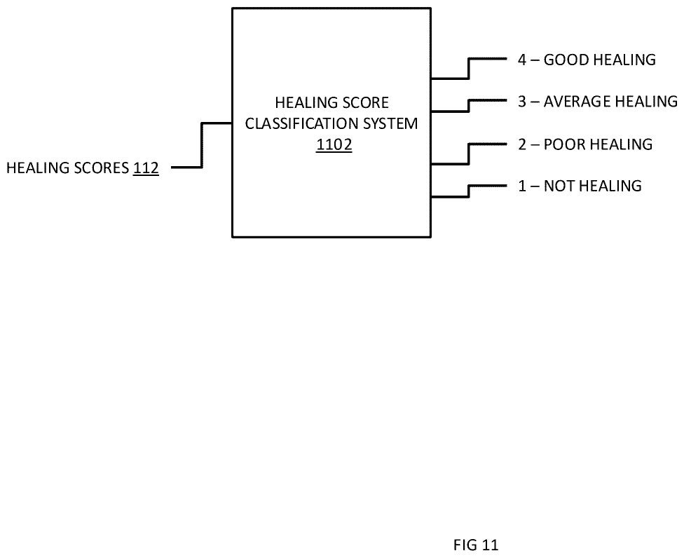

The platform generates healing scores 112 classified into four distinct categories: 1—not healing, 2—poor healing, 3—average healing, and 4—good healing. As illustrated in FIG. 11, the GCN 902 outputs healing scores 112 of soft tissue regions that received implants based on uncertainty 708 and representativeness 706 actively learned from WGAN synthesized pure pixel images and additional physics information 602.

The healing score 112 is further enhanced by integration with physician-supplied attributes 110 such as time period for healing, patient age, comorbidities, and health condition. The multi-architectural AI system uses these attributes to improve the predicted healing score of tissue regions surrounding the implant.

The healing score 112 serves multiple clinical purposes: it guides post-surgical therapeutic direction, provides feedback to implant design, implant chemistries, and implant methods, and enables objective assessment of tissue healing progress.

### Advanced AI Services and Multi-Modal Integration

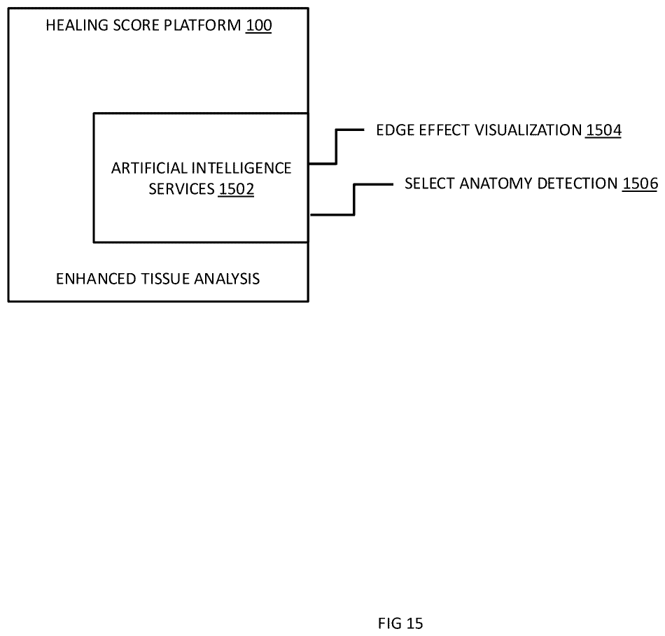

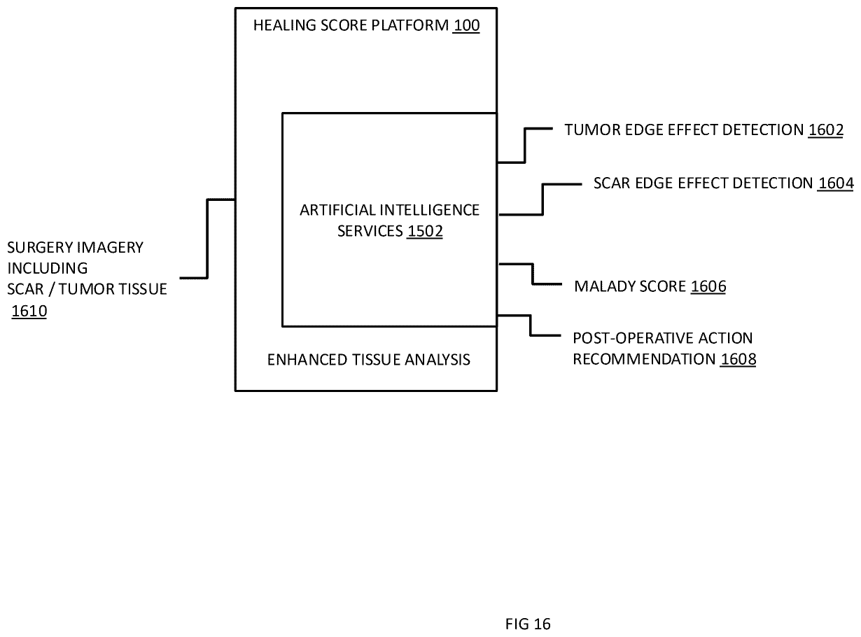

Referring to FIG. 15, the platform includes artificial intelligence services 1502 trained to facilitate detecting and visualizing edge effects of tissue, including tumor edge visualization 1504 and select anatomy detection 1506. These services 1502 are further trained to detect select tissue including tumor tissue 1602 and scar tissue 1604 as depicted in FIG. 16 and predict corresponding impact on the healing score 112.

Referring to FIG. 16, the impact on the healing score represents a malady score 1606, with images of tumor or scar tissue captured during surgery being processed by the system. The AI services 1502 provide recommendations 1608 for surgical actions to improve post-operative healing, avoid surgical errors, and reduce likelihood of requiring re-operation.

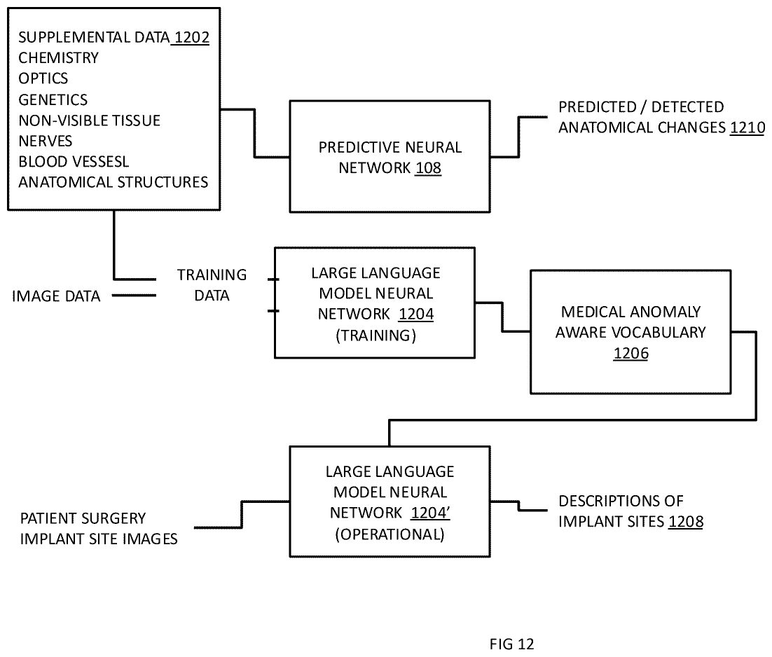

As shown in FIG. 12, the platform processes supplemental data 1202 representative of chemistry, optics, genetics, and non-visible tissue and related anatomy including nerves, blood vessels, and anatomical structures. The predictive neural network 108 processes this supplemental data 1202 to predict and/or detect anatomical changes.

### Large Language Model Integration

Referring again to FIG. 12, the platform optionally incorporates a large language model neural network system 1204 configured with features and structures trained from supplemental data and images of surgery-patient implant sites and sources of medical science and practice to develop a medical anomaly-aware vocabulary 1206. This large-language model 1204 processes the medical anomaly-aware vocabulary 1206 with images of surgery-patient implant sites to facilitate descriptions of implant sites 1208 with respect to the healing score 112.

### Clinical Validation and Performance

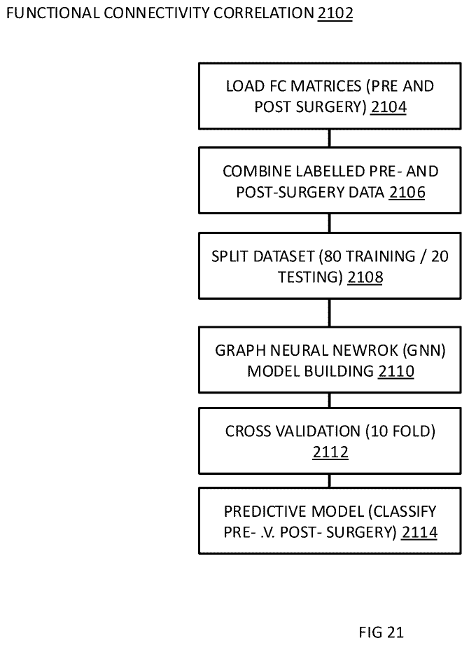

The platform's effectiveness is demonstrated through comprehensive clinical validation, as illustrated in the brain tumor case study (FIG. 21). The system processes functional connectivity matrices 1308 derived from brain scans, implementing a binary classification workflow 1306 to distinguish between pre-surgery and post-surgery brain states.

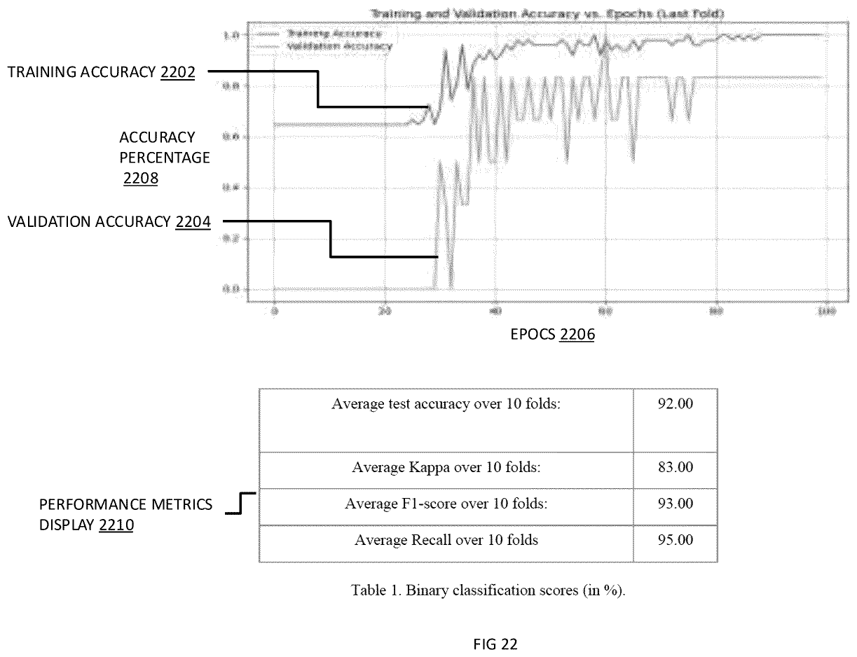

The validation methodology employs 10-fold cross-validation 1800 that splits data into ten parts, trains the model on nine parts, and tests on the remaining part, repeated ten times. As shown in FIG. 22, the system achieves remarkable performance metrics 1304: 92% average accuracy, 83% Kappa score, 93% F1-score, and 95% Recall.

The dataset processing involves an 80-20 training/testing split methodology 1404 with functional connectivity matrices representing connectivity between 114 regions of interest 1406 in the brain. Each training sample consists of a 114×114 FC matrix, demonstrating the platform's capability to handle complex medical imaging data.

### Implementation Variations and Embodiments

The platform supports various implementation configurations. The training set can be generated from MRI images, CT images, ultrasound images, or other medical imaging modalities. The predictive neural network 108 can process post-surgical implant MRI images, real-time surgical images, or follow-up imaging studies.

The platform is particularly suited for bio-scaffold tissue implants 1408 but can be adapted for orthopedic implants, cardiac implants, and other surgical implant applications. The system provides specific integration with implant design feedback systems, enabling continuous improvement of implant technologies.

The following provides detailed description of the figures.

FIG. 1 illustrates the comprehensive platform for predicting changes in tissue post-surgery, showing the integration of three primary components as described in the invention. The diagram depicts a training set of images 102 of tissue regions of interest prepared from a set of tissue images 101 with a neural network having an autoencoder architecture 104, connected to a physics model 106 of surgical implant effects that uses representativeness and uncertainty measurement techniques, which feeds into a healing score predictive neural network 108. The data flow shows input tissue images 101 being processed through the autoencoder architecture 104 to generate regions of interest, which are then analyzed by the physics model 106 incorporating patient attributes 110 such as time period for healing, patient age, comorbidities, and patient health condition, ultimately producing healing scores 112 indicative of the degree of healing.

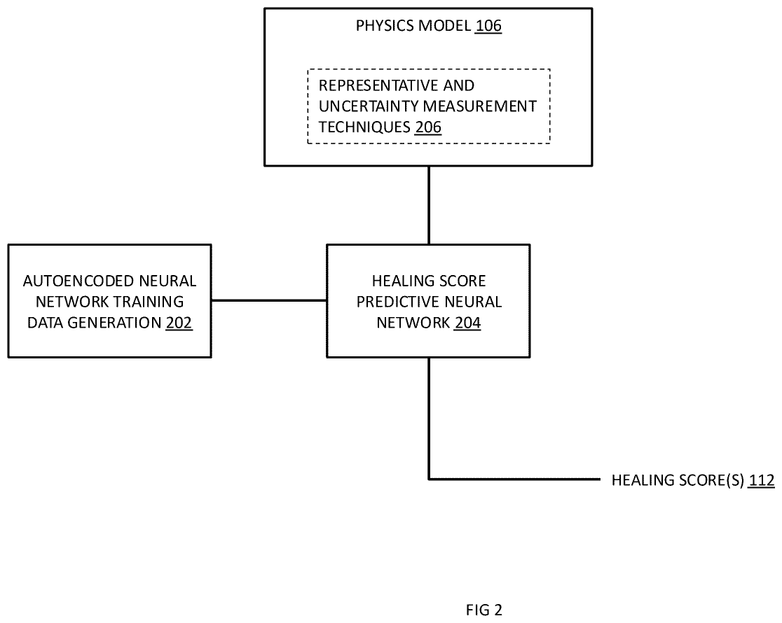

FIG. 2 provides a detailed view of the dual neural network system, specifically illustrating the first neural network 202 having an autoencoder architecture for generating a training set of tissue regions of interest, and the second neural network 204 trained with the training set to predict a healing score representative of changes in the regions of interest of post-surgery patient tissue images. The diagram shows how the second neural network 204 operates the physics model 106 of surgical implant effects using representativeness and uncertainty measurement techniques 206, with clear pathways between the training data generation and the predictive modeling components.

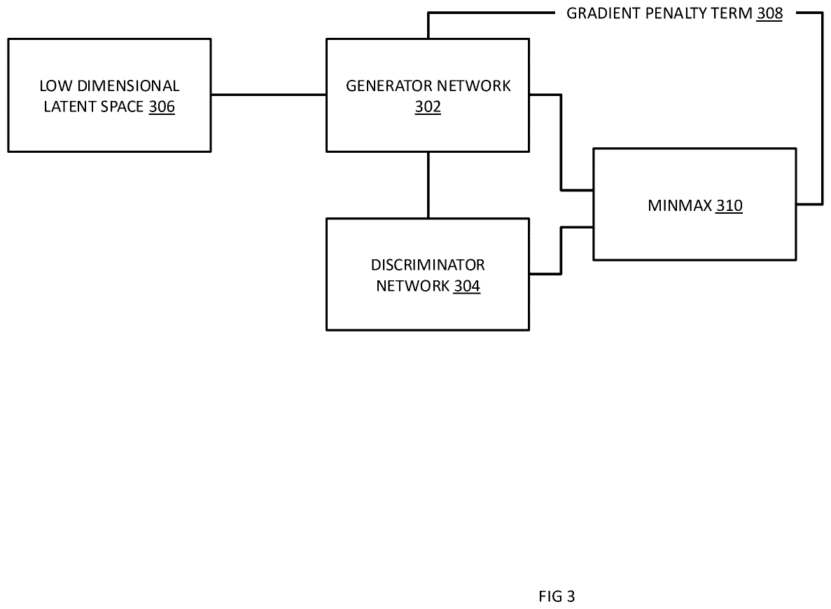

FIG. 3 depicts a Wasserstein Generative Adversarial Network embodiment, showing the generator network 302 and discriminator network 304 as multilayer perceptron (MLP) networks. This figure is representative of elements of mathematical formulation (1), where pt is the probability density function of the original image and pz is the pdf of the noise or latent space 306. This figure shows the minmax training process 310 where the generator 302 maximizes error while the discriminator 304 minimizes error and includes the penalty term 308 of mathematical formula (4) to avoid vanishing or explosion gradients.

FIG. 4 details the blind deconvolution autoencoder architecture 104 used for obtaining pure pixel regions of interest from bio-scaffold tissue images, where pure is defined as undamaged or unaltered tissue samples. The diagram shows the nonsymmetric autoencoder structure consisting of 2-dimensional convolutional operations 402, batch normalization 404, flatten 406, dense 408, and softmax operations 410 to extract fractional abundances of non-pure pixels that may have mixture constituents representing damaged or modified tissue samples. This figure illustrates how this autoencoder 104 performs blind deconvolution to identify portions of regions of interest that define undamaged/unaltered tissue samples 412, with portions defined by sets of pixels in MRI images.

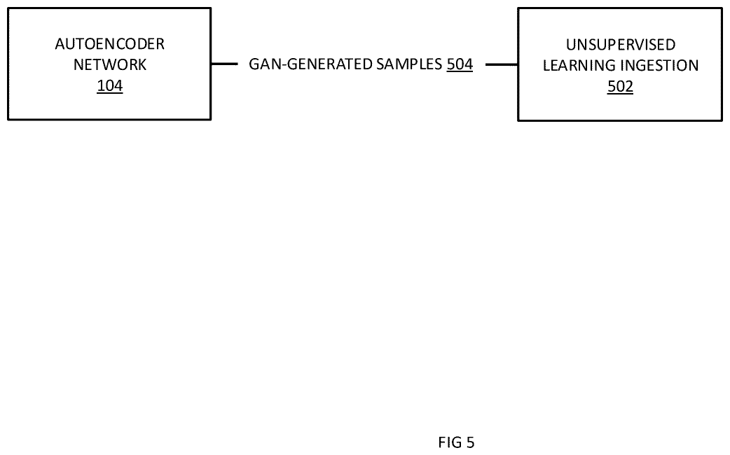

FIG. 5 shows the complete workflow for generating training sample regions of interest using Wasserstein Generative Adversarial Networks and autoencoder architecture. The diagram illustrates how the output of the autoencoder 104 becomes input to the next stage 502 for unsupervised feature learning as a component of the active learning mechanism for prediction of healing scores, demonstrating the integration between the GAN-generated samples 504 and the subsequent processing stages.

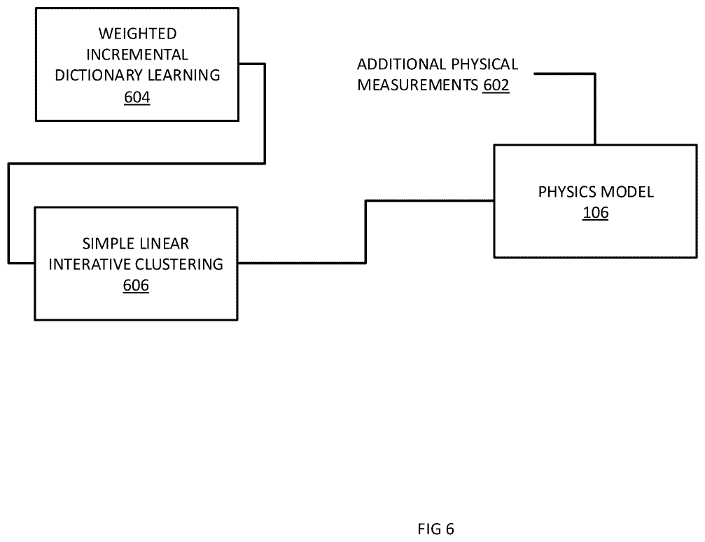

FIG. 6 illustrates the physics-informed modeling of implant effects using representativeness and uncertainty measurements to predict changes in soft tissue post-surgery. The diagram shows how the physics model 106 incorporates additional physics measurements 602 for labeling tissue images, with active learning categorized into uncertainty-based, performance-based, and representativeness-based approaches. This figure depicts the integration of weighted incremental dictionary learning (WI-DL) 604 to optimize the objective function and how geometric simple linear iterative clustering (SLIC) 606 is applied to unlabeled image data using an elliptic kernel.

FIG. 7 details the weighted incremental dictionary learning process 604 for improving accuracy of predicting healing scores, showing how the facility distinguishes among representative samples 702 and uncertain samples 704 from a set of samples 716 to prepare an incremental training set. The diagram shows how representativeness measurement 706 is based on projecting samples to Grassman manifold 712 while uncertainty measurement 708 uses entropy calculations 710.

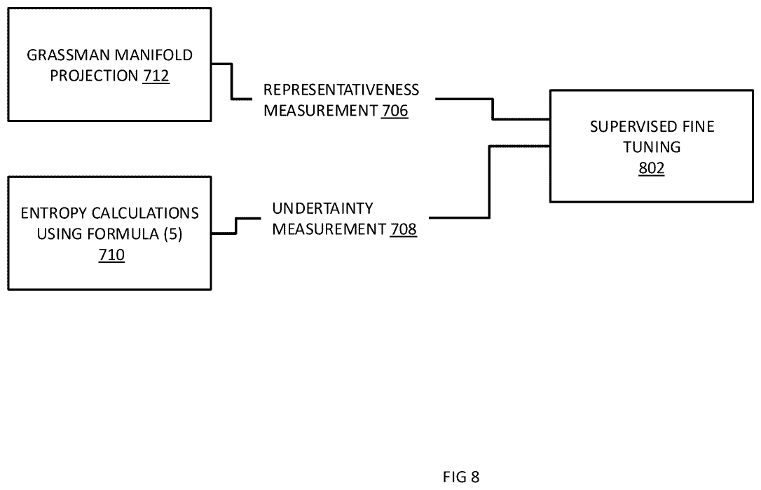

FIG. 8 provides visualization of the uncertainty measurement calculation 708 using entropy of mathematical formula (5), where p (yj|x) is the probability that sample x belongs to the jth class. The diagram shows the Grassman manifold projection process 712 for representativeness measurement and illustrates how these measurements integrate with the supervised fine-tuning block 802 for the Graph Convolution Network classifier.

FIG. 9 depicts the GCN classifier 902 requiring construction of an adjacency matrix 904 representing pixel (node) relationships as edges of an undirected graph. The diagram shows the four GCN layers 906 each with 64 units and ReLU activation that sequentially process graph data, followed by global average pooling 908 applied to the output of the last GCN layer, and a dense layer 910 with single output unit and sigmoid activation function for binary classification tasks. This figure illustrates how GCN 902 performs convolution operations on non-Euclidean graph structures to handle complex topologies.

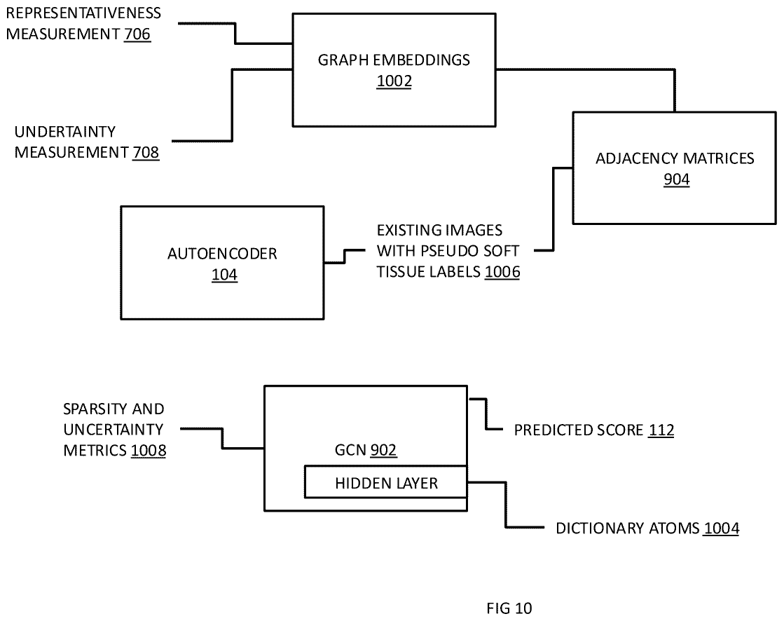

FIG. 10 shows adjacency matrices 904 constructed from graph embeddings 1002 of representativeness measurements 706, uncertainty measurements 708 from physician information, and existing images with pseudo soft tissue labels 1006 from the autoencoder 104. The diagram illustrates how dictionary atoms 1004 are obtained from the hidden layer of the GCN 902, which can be considered as feature learning and dimensionality reduction, and how selected samples from sparsity and uncertainty metrics 1008 are used to train the GCN classifier 902, such as to predict healing scores.

FIG. 11 illustrates the four-category healing score classification system 1102: 1—not healing, 2—poor healing, 3—average healing, and 4—good healing.

FIG. 12 shows the integration of supplemental data 1202 representative of chemistry, optics, genetics, and non-visible tissue and related anatomy including nerves, blood vessels, and anatomical structures. The diagram illustrates how the predictive neural network 108 processes supplemental data 1202 to predict and/or detect anatomical changes 1210 and shows the large language model neural network system 1204 trained from supplemental data and images to develop a medical anomaly-aware vocabulary 1206. This figure depicts how the large-language model 1204 processes the medical anomaly-aware vocabulary 1206 with images of surgery-patient implant sites to facilitate descriptions of implant sites 1208 with respect to healing scores 112.

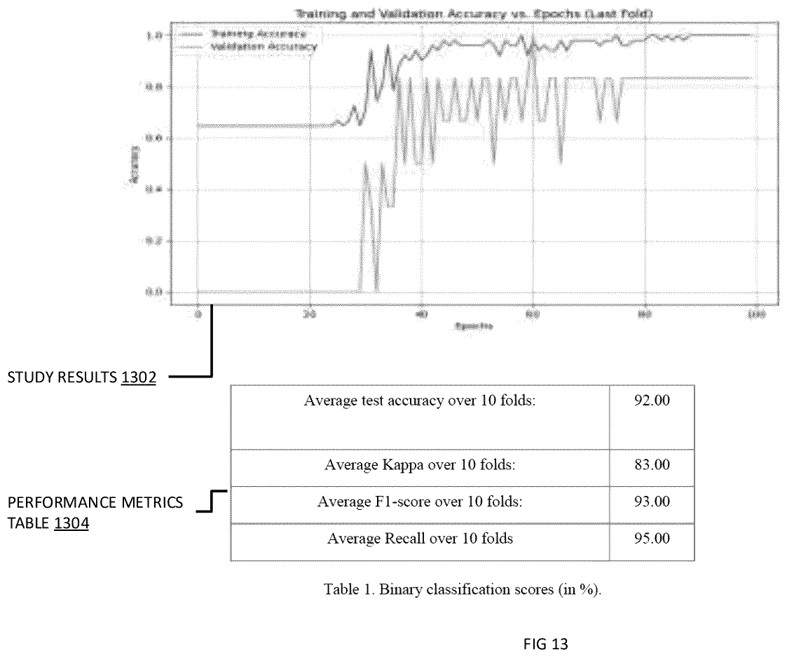

FIG. 13 presents the proof-of-concept brain tumor case study results, showing the ten-fold cross-validation accuracy 1302 obtained for each fold with an average accuracy of 92%. The diagram includes the performance metrics table 1304 showing Kappa score of 83%, F1-score of 93%, and Recall of 95%.

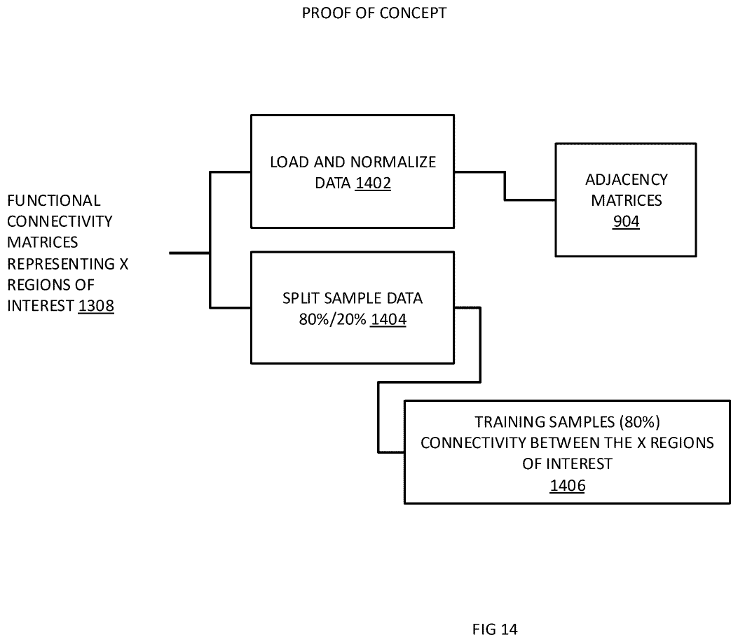

FIG. 14 shows how FC matrices 1308 are loaded and converted 1402 into normalized adjacency matrices 904. The diagram depicts the 80-20 training/testing split methodology 1404 with 50 samples assigned to training and 13 to testing, where each training sample is a 114×114 FC matrix representing connectivity between 114 regions of interest 1406 in the brain.

FIG. 15 illustrates the artificial intelligence services 1502 trained to facilitate detecting and visualizing edge effects of tissue, including tumor edge visualization 1504 and select anatomy detection 1506. The diagram shows how these services 1502 integrate with the main healing score prediction platform to provide enhanced tissue analysis capabilities.

FIG. 16 depicts the artificial intelligence services 1502 trained to detect select tissue including tumor tissue 1602 and scar tissue 1604 and predict corresponding impact on the healing score 112. The diagram shows an impact on healing score represented as a malady score 1606 and illustrates how images of tumor or scar tissue captured during surgery 1610 are processed. This figure demonstrates how the AI services 1502 provide recommendations 1608 for surgical actions to improve post-operative healing, avoid surgical errors, and reduce likelihood of requiring re-operation.

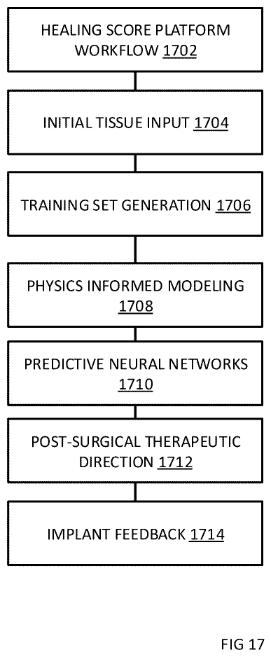

FIG. 17 provides an end-to-end view of the entire platform workflow 1702, from initial tissue image input 1704 through healing score output 112 and clinical decision support providing comprehensive post-surgical monitoring and assessment capabilities. The diagram integrates all major components described across the independent claims, showing how the training set generation 1706, physics-informed modeling 1708, and predictive neural networks 1710 work together to guide post-surgical therapeutic direction 1712 and provide feedback 1714 to implant design, implant chemistries, and implant methods.

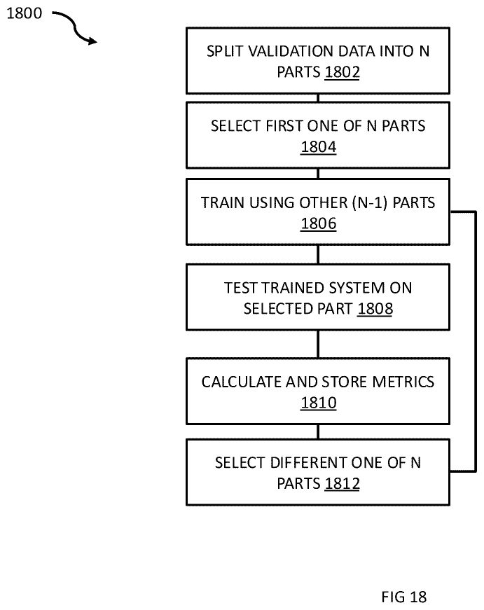

FIG. 18 illustrates the comprehensive evaluation methodology 1800 using different case studies and ground truth healing score databases to evaluate the AI system's performance. The diagram shows the 10-fold cross-validation implementation 1800 that splits data into ten parts 1802, selects one part 1804, trains the model on nine parts 1806, and tests on the remaining part 1808, repeated ten times 1812 with different metrics including accuracy, Kappa score, F1-score, recall, and confusion matrix calculations 1810. This figure demonstrates a technique for refinement and improvement to the AI systems.

FIG. 19 illustrates an embodiment of a Wasserstein Generative Adversarial Network (WGAN) architecture for generating regions of interest samples from actual MRI images. The system begins with a low dimensional latent space 1902 that provides input to the generator network 1904. The generator 1904 produces generated samples 1906 that are evaluated by the discriminator network 1908 through a cost function 1910.

The discriminator 1908 compares the generated samples 1906 against real 2D medical images 1914 representing smooth tissue and tendons. The system implements gradient backpropagation 1912 to optimize the network performance through the minmax training algorithm where the generator 1904 maximizes error while the discriminator 1908 minimizes error.

The generated samples 1906 are then processed through a blind deconvolution autoencoder 1916 that performs unsupervised pure pixel tissue image sampling. This autoencoder 1916 outputs region of interest samples 1918 that represent pure tissue endmembers, where pure is defined as undamaged or unaltered tissue samples. The workflow demonstrates how GANs can improve image classification when there are fewer labeled samples due to the difficulty and high cost in collecting labeled samples.

FIG. 20 depicts the comprehensive physics-informed AI model architecture that processes GAN samples from FIG. 19 (element 2002) along with 2D medical images 2004 of smooth tissue and tendons. The system implements unsupervised feature learning 2006 as a component of the active learning mechanism for prediction of healing scores.

The architecture incorporates geometric simple linear iterative clustering (SLIC) 2014 applied to unlabeled image data using an elliptic kernel. The system utilizes weighted incremental dictionary learning (WI-DL) 2016 to optimize the objective function and identify the most representative samples of inflammation/reaction 2018.

Physics informed uncertainty measurement 2020 is implemented using entropy calculations, while the supervised fine tune component 2008 processes the data for representativeness measurement based on projecting samples to Grassman manifold. The change prediction by GCN 2010 utilizes Graph Convolutional Networks that perform convolution operations on non-Euclidean graph structures to handle complex topologies. The final output is the generation of a healing score 2012 that classifies tissue healing into categories of not healing, poor healing, average healing, and good healing.

FIG. 21 presents the block diagram of the AI workflow for classifying brain regions of interest into tumorous and non-tumorous classes as a proof-of-concept implementation. The process begins with functional connectivity Pearson correlation 2102 data input.

The workflow loads FC matrices 2104 for both pre-surgery and post-surgery data, where the dataset contains 63 samples representing functional connectivity matrices derived from brain scans. There are 25 pre-surgery samples and 17 post-surgery samples for patients, plus 11 pre-surgery samples and 10 post-surgery samples for the control group.

The system combines the pre-surgery and post-surgery data along with their labels 2106 into a single dataset, then splits the dataset 2108 using an 80-20 split for training and testing sets. After this split, 50 samples are assigned to the training set and 13 to the testing set, where each training sample is a 114×114 FC matrix representing connectivity between 114 regions of interest in the brain.

The Graph Neural Network (GNN) model building 2110 constructs the classification system, followed by cross-validation 2112 using 10-fold methodology to evaluate model performance. The final predictive model 2114 classifies the state of the brain as pre-surgery versus post-surgery, demonstrating the system's capability for binary classification tasks.

FIG. 22 displays the performance validation results for the brain tumor classification system, showing both training accuracy 2202 and validation accuracy 2204 curves plotted against epochs 2206 on the accuracy percentage axis 2208. The graph demonstrates the training and validation accuracy versus epochs for the last fold of the cross-validation process.

The performance metrics display 2210 shows the comprehensive evaluation results achieved through the 10-fold cross-validation methodology. The system achieves an average test accuracy of 92% over 10 folds, with additional metrics including an average Kappa score of 83%, average F1-score of 93%, and average Recall of 95%.

This validation framework demonstrates that the codes use 10-fold cross-validation to evaluate the model's performance by splitting the data into ten parts, training the model on nine parts, and testing it on the remaining part. This process is repeated ten times, with each part used as the test set once, and different metrics such as accuracy, Kappa score, F1-score, recall, and confusion matrix are calculated and stored.

The following paragraphs describe alternative embodiments and variations of the healing score prediction methods and systems described herein.

### Neural Network Architecture Variations

### Alternative Autoencoder Implementations

The platform's autoencoder architecture 104 can be implemented using various neural network configurations beyond the disclosed blind deconvolution approach. Alternative embodiments include variational autoencoders (VAEs) that incorporate probabilistic encoding and decoding mechanisms for generating tissue regions of interest. The autoencoder may utilize residual connections, attention mechanisms, or transformer-based architectures to enhance feature extraction from medical images.

In another embodiment, the autoencoder architecture 104 may employ cascaded autoencoder networks where multiple autoencoders are trained sequentially, with each subsequent autoencoder refining the regions of interest identified by the previous network. The autoencoder may also implement multi-scale processing, where different resolution levels of the input images are processed simultaneously to capture both fine-grained tissue details and broader anatomical context.

### Graph Neural Network Variations

While the disclosed embodiment utilizes Graph Convolutional Networks (GCNs) with four layers having 64 units each, alternative implementations may employ different graph neural network architectures. Graph Attention Networks (GATs) can be substituted to provide attention-weighted aggregation of neighboring node features, allowing the system to focus on the most relevant tissue regions for healing assessment.

Alternative embodiments may implement Graph Transformer networks that combine the benefits of transformer attention mechanisms with graph structure processing. The adjacency matrix 904 construction can be varied to use different connectivity patterns, including learned adjacency matrices where the graph structure is optimized during training rather than being predetermined.

### Generative Network Alternatives

Beyond the disclosed Wasserstein GAN implementation, the platform may utilize alternative generative models. Variational Autoencoders (VAEs) can replace the WGAN architecture for generating synthetic training data, providing explicit probabilistic modeling of the latent space 306. Progressive GANs may be employed to generate high-resolution medical images through progressive training at increasing resolutions.

Diffusion models represent another alternative embodiment for generating synthetic medical images, offering stable training dynamics and high-quality image generation. These models can be conditioned on specific patient attributes 110 or healing conditions to generate targeted synthetic training data.

### Imaging Modality Variations

### Multi-Modal Imaging Integration

While the primary disclosure focuses on MRI images, the platform can be adapted for various imaging modalities. Computed Tomography (CT) scan processing represents a significant alternative embodiment, where the autoencoder architecture 104 is modified to handle the different contrast characteristics and spatial resolution of CT images. The physics model 106 would incorporate CT-specific tissue interaction principles and Hounsfield unit analysis.

Ultrasound imaging integration provides real-time assessment capabilities, where the platform processes dynamic ultrasound sequences to track tissue healing progression. The neural networks would be adapted to handle temporal sequences and the unique acoustic properties of ultrasound imaging. The healing score 112 generation would incorporate motion analysis and tissue elasticity measurements derived from ultrasound data.

### Advanced Imaging Techniques

Positron Emission Tomography (PET) integration enables metabolic assessment of tissue healing, where the platform analyzes glucose uptake patterns and metabolic activity around implant sites. The supplemental data 1202 processing would incorporate radiopharmaceutical distribution patterns and metabolic rate calculations.

Optical Coherence Tomography (OCT) represents another embodiment for high-resolution tissue microstructure analysis. The platform would process OCT images to assess tissue organization, collagen fiber alignment, and vascular development around implant sites. The autoencoder 104 would be specifically trained to identify OCT-specific tissue features and healing indicators.

### Hybrid Imaging Approaches

Multi-modal fusion embodiments combine multiple imaging modalities simultaneously. For example, MRI-PET fusion processing would integrate anatomical detail from MRI with metabolic information from PET scans. The neural networks would process registered multi-modal datasets, with the physics model 106 incorporating cross-modal correlation analysis and joint feature extraction.

### Clinical Application Extensions

### Orthopedic Implant Applications

Beyond the disclosed bio-scaffold tissue implants, the platform can be adapted for orthopedic implant assessment. Joint replacement monitoring represents a significant alternative embodiment, where the system analyzes bone-implant integration, osseointegration progress, and periprosthetic tissue health. The healing score 112 would incorporate bone density measurements, implant stability indicators, and inflammatory response assessment.

Spinal fusion monitoring provides another orthopedic application, where the platform tracks bone graft incorporation, fusion mass development, and adjacent segment health. The physics model 106 would incorporate biomechanical stress analysis and bone remodeling principles specific to spinal fusion procedures.

### Cardiovascular Implant Monitoring

Cardiac implant applications represent a major alternative embodiment category. Pacemaker and defibrillator lead assessment involves analyzing lead integrity, tissue encapsulation, and electrical impedance changes over time. The platform would process cardiac imaging data to generate healing scores 112 specific to cardiac tissue response and lead stability.

Vascular stent monitoring provides another cardiovascular application, where the system analyzes vessel wall healing, neointimal hyperplasia development, and stent endothelialization. The neural networks would be trained to identify vascular-specific healing patterns and predict restenosis risk.

### Neurological Implant Applications

Deep brain stimulation (DBS) electrode monitoring represents a specialized neurological application. The platform would analyze brain tissue response around electrode implants, assess blood-brain barrier integrity, and monitor for inflammatory responses. The healing score 112 would incorporate neurological function indicators and electrode impedance measurements.

Cochlear implant assessment provides another neurological application, where the system monitors inner ear tissue response, electrode array positioning, and neural interface development. The platform would process specialized inner car imaging to assess implant integration and predict hearing outcomes.

### Ophthalmologic Implant Applications

Intraocular lens monitoring represents an ophthalmologic embodiment, where the platform analyzes capsular bag healing, lens positioning stability, and posterior capsule opacification development. The system would process specialized ocular imaging modalities and generate healing scores 112 specific to ocular tissue response.

Retinal implant assessment provides another ophthalmologic application, where the platform monitors retinal tissue response, implant-retina interface development, and visual function correlation. The neural networks would be adapted to process retinal imaging data and predict visual rehabilitation outcomes.

### Specialized Physics Models

### Tissue-Specific Modeling

Different clinical applications require specialized physics models 106 tailored to specific tissue types. Bone healing physics models incorporate mechanobiology principles, stress-strain relationships, and bone remodeling algorithms. These models would analyze mechanical loading patterns, bone density changes, and mineralization processes around orthopedic implants.

Soft tissue healing models focus on collagen synthesis, angiogenesis, and inflammatory response dynamics. These physics models 106 would incorporate wound healing cascade modeling, growth factor diffusion analysis, and tissue mechanical property evolution.

### Material-Specific Considerations

Different implant materials require specialized physics modeling approaches. Titanium implant models would incorporate osseointegration kinetics, surface roughness effects, and corrosion resistance analysis. Polymer implant models would focus on biodegradation rates, mechanical property changes over time, and biocompatibility assessment.

Bioactive material models would incorporate controlled release kinetics, drug elution profiles, and therapeutic agent distribution patterns. These specialized physics models 106 would predict healing enhancement effects and optimize therapeutic delivery strategies.

### Advanced AI Service Extensions

### Predictive Complication Detection

Advanced AI services 1502 can be extended to predict specific complications beyond the disclosed tumor and scar tissue detection. Infection prediction services would analyze imaging patterns indicative of bacterial colonization, biofilm formation, and immune response activation. These services would provide early warning systems for implant-related infections.

Mechanical failure prediction represents another advanced service extension, where AI algorithms analyze stress concentration patterns, material fatigue indicators, and implant positioning changes to predict mechanical complications before clinical manifestation.

### Personalized Treatment Optimization

AI services 1502 can be extended to provide personalized treatment recommendations based on individual patient characteristics and healing patterns. These services would analyze patient-specific factors including genetic markers, metabolic profiles, and healing history to optimize post-surgical care protocols.

Rehabilitation planning services would generate customized physical therapy protocols, activity restrictions, and follow-up schedules based on predicted healing trajectories and individual patient risk factors.

The following paragraphs describe additional applications for a healing score.

### Orthopedic Implant Applications

### Joint Replacement Monitoring

For orthopedic joint replacement applications, the platform adapts its healing score metrics to assess bone-implant integration and osseointegration progress. The physics model 106 incorporates biomechanical principles specific to bone healing, including stress-strain relationships, bone remodeling algorithms, and mechanical loading patterns around the implant site.

The healing score 112 for orthopedic applications is modified to include bone-specific healing indicators: (1) no osseointegration-indicating poor bone-implant contact and potential loosening, (2) partial osseointegration-showing limited bone growth around the implant, (3) progressive osseointegration-demonstrating active bone remodeling and integration, and (4) complete osseointegration-indicating optimal bone-implant fusion with stable mechanical fixation.

The autoencoder architecture 104 is trained to identify pure pixel regions representing healthy bone tissue versus damaged or necrotic bone areas around the implant. The supplemental data 1202 processing incorporates bone density measurements, cortical thickness analysis, and trabecular bone architecture assessment to enhance healing score prediction accuracy.

### Spinal Fusion Assessment

For spinal fusion applications, the platform's neural networks are adapted to process imaging data showing vertebral bone graft incorporation and fusion mass development. The physics model 106 integrates biomechanical stress analysis specific to spinal loading conditions and bone remodeling principles governing fusion progression.

The healing score categories are tailored to spinal fusion outcomes: (1) pseudarthrosis-indicating failed fusion with persistent motion, (2) delayed union-showing slow but progressing fusion, (3) developing fusion-demonstrating active bone bridge formation, and (4) solid fusion-indicating complete bony union with mechanical stability.

### Cardiac Implant Applications

### Pacemaker and Defibrillator Lead Assessment

For cardiac implant monitoring, the platform processes cardiac imaging data to assess lead integrity, tissue encapsulation, and electrical impedance changes over time. The physics model 106 incorporates cardiac tissue-specific healing principles, including fibrotic encapsulation dynamics and electrical conduction properties.

The cardiac healing score metrics are adapted to evaluate: (1) lead dysfunction-indicating poor tissue integration with high impedance or sensing issues, (2) suboptimal integration-showing excessive fibrotic response affecting device function, (3) stable integration-demonstrating appropriate tissue encapsulation with normal electrical parameters, and (4) optimal integration-indicating ideal tissue response with excellent long-term stability.

The artificial intelligence services 1502 are trained to detect cardiac-specific tissue responses, including excessive fibrosis formation around leads and inflammatory responses that could affect device function. The system provides recommendations 1608 for programming adjustments or intervention strategies to optimize cardiac device performance.

### Vascular Stent Monitoring

For vascular stent applications, the platform analyzes vessel wall healing, neointimal hyperplasia development, and stent endothelialization progress. The physics model 106 incorporates hemodynamic principles, shear stress analysis, and vascular remodeling mechanisms specific to stented vessels.

The vascular healing score categories address: (1) restenosis risk—indicating excessive neointimal proliferation, (2) delayed healing—showing slow endothelialization with thrombosis risk, (3) progressive healing—demonstrating appropriate vessel wall remodeling, and (4) complete healing—indicating optimal endothelialization with restored vessel function.

### Neural Implant Applications

### Deep Brain Stimulation (DBS) Electrode Monitoring

For neurological applications involving deep brain stimulation electrodes, the platform analyzes brain tissue response around electrode implants and assesses blood-brain barrier integrity. The physics model 106 incorporates neurological tissue-specific healing principles, including glial scar formation, neuroinflammatory responses, and electrode-tissue interface stability.

The neurological healing score metrics evaluate: (1) significant gliosis-indicating excessive glial scar formation affecting electrode function, (2) moderate tissue response-showing controlled inflammatory reaction, (3) stable integration-demonstrating appropriate tissue accommodation with maintained electrode performance, and (4) optimal integration-indicating minimal tissue reaction with excellent long-term electrode stability.

The large language model neural network system 1204 is trained with neurological terminology and develops a medical anomaly-aware vocabulary 1206 specific to neural tissue responses, enabling detailed descriptions of electrode-brain tissue interfaces.

### Cochlear Implant Assessment

For cochlear implant applications, the platform monitors inner ear tissue response, electrode array positioning, and neural interface development. The physics model 106 incorporates acoustic principles and neural stimulation parameters specific to auditory system function.

The auditory healing score categories address: (1) poor neural interface-indicating limited spiral ganglion cell survival or electrode migration, (2) suboptimal positioning-showing electrode displacement affecting frequency mapping, (3) stable positioning-demonstrating appropriate electrode placement with developing neural interface, and (4) optimal integration-indicating ideal electrode positioning with excellent neural stimulation thresholds.

### Implant Material-Specific Adaptations

### Titanium Implant Processing

For titanium-based implants commonly used in orthopedic and dental applications, the autoencoder architecture 104 is specifically trained to identify titanium-tissue interface characteristics. The physics model 106 incorporates osseointegration kinetics specific to titanium surface properties, including surface roughness effects and corrosion resistance analysis.

The healing score 112 for titanium implants emphasizes bone-metal interface quality, with categories addressing: (1) fibrous encapsulation-indicating poor osseointegration, (2) partial bone contact-showing limited direct bone-implant interface, (3) developing osseointegration-demonstrating progressive bone growth onto titanium surface, and (4) complete osseointegration-indicating direct bone-titanium contact without intervening soft tissue.

### Polymer and Bioabsorbable Implant Assessment

For polymer-based and bioabsorbable implants, the platform tracks material degradation rates and tissue replacement processes. The physics model 106 incorporates biodegradation kinetics, mechanical property changes over time, and biocompatibility assessment specific to polymer materials.

The healing score categories for bioabsorbable implants evaluate: (1) premature degradation—indicating rapid material breakdown before tissue healing, (2) delayed resorption—showing slow material absorption with prolonged inflammatory response, (3) controlled degradation—demonstrating appropriate material resorption with tissue replacement, and (4) complete integration—indicating optimal material resorption with full tissue regeneration.

### Cross-Platform Integration and Validation

The platform's adaptability across different implant types is validated through the comprehensive evaluation methodology that can be applied to various clinical scenarios. The 10-fold cross-validation implementation is adapted for each implant type, with performance metrics tailored to the specific clinical outcomes relevant to each application.

The complete system workflow 1702 maintains consistency across all implant types while allowing for specialized processing pathways based on the specific implant category and clinical application. This ensures that the healing score 112 generation remains standardized and comparable across different surgical specialties while maintaining clinical relevance for each specific application.

### Inventive Statements:

In some aspects, the techniques described herein relate to predicting tissue changes post-surgery

In some aspects, the techniques described herein relate to a platform for predicting changes in tissue post-surgery having a training set of images of tissue regions of interest, the training set prepared from a set of tissue images with a neural network having an autoencoder architecture; a physics model of surgical implant effects that uses representativeness and uncertainty measurement techniques to facilitate predicting post-surgery changes to surgery-patient implant sites; and a healing score predictive neural network classifying images of the surgery-patient implant sites against a range of healing scores indicative of a degree of healing, the predictive neural network further predicting changes over time of a healing score for a patient.

In some aspects, the techniques described herein relate to a platform, wherein the healing score is further based on patient or surgery attributes including one or more of time period for healing, patient age, comorbidities, and patient health condition.

In some aspects, the techniques described herein relate to a platform, wherein the implant is a bio-scaffold tissue implant.

In some aspects, the techniques described herein relate to a platform, wherein the training set generated from MRI images.

In some aspects, the techniques described herein relate to a platform, wherein the second/predictive neural network processing post-surgical implant MRI images.

In some aspects, the techniques described herein relate to a platform, wherein the autoencoder architecture performs blind deconvolution when generating the regions of interest.

In some aspects, the techniques described herein relate to a platform, wherein the autoencoder architecture performs blind deconvolution to identify portions of the regions of interest that define undamaged/unaltered tissue samples

In some aspects, the techniques described herein relate to a platform, wherein the portions of the regions of interest are defined by a set of pixels in an MRI Image.

In some aspects, the techniques described herein relate to a platform, where the range of healing scores includes: not healing, poor healing, average healing, and good healing.

In some aspects, the techniques described herein relate to a platform, wherein the healing score guides post-surgical therapeutic direction.

In some aspects, the techniques described herein relate to a platform, wherein the healing score provides feedback to implant design, implant chemistries, and implant methods.

In some aspects, the techniques described herein relate to a platform further including a set of artificial intelligence services trained to facilitate detecting and visualizing edge effects of tissue, including one or more of tumor edge visualization, or select anatomy detection.

In some aspects, the techniques described herein relate to a platform further including a set of artificial intelligence services trained to detect select tissue including tumor tissue, scar tissue and to predict a corresponding impact on the healing score.

In some aspects, the techniques described herein relate to a platform, wherein the impact on the healing score represents a malady score.

In some aspects, the techniques described herein relate to a platform, wherein images the tumor or scar tissue are captured during surgery.

In some aspects, the techniques described herein relate to a platform, wherein the set of artificial intelligence services provides a set of recommendations for at least one of surgical actions to improve post-operative healing, avoid surgical errors, and reduce a likelihood of requiring re-operation.

In some aspects, the techniques described herein relate to a platform, wherein the healing score is further based on supplemental data representative of chemistry, optics, genetics, non-visible tissue and related anatomy including nerves, blood vessels, anatomical structures.

In some aspects, the techniques described herein relate to a platform, wherein the predictive neural network processes the supplemental data to predict and/or detect anatomical changes.

In some aspects, the techniques described herein relate to a platform, wherein the predictive neural network is further configured with large language model features and structures trained from the supplemental data and the images of the surgery-patient implant sites and sources of medical science and practice to develop a medical anomaly-aware vocabulary.

In some aspects, the techniques described herein relate to a platform, wherein a large-language model neural network system processes the medical anomaly-aware vocabulary with the images of the surgery-patient implant sites to facilitate a description of the implant sites with respect to the healing score.

In some aspects, the techniques described herein relate to a platform, wherein the training set is generated from one or more of: MRI images, CT images, ultrasound images, or histological images.

In some aspects, the techniques described herein relate to a platform, wherein the predictive neural network processes, post-surgical implant MRI images, real-time surgical images, or follow-up imaging studies.

In some aspects, the techniques described herein relate to a platform, wherein the autoencoder architecture performs one or more of: blind deconvolution when generating the regions of interest, feature extraction, or dimensionality reduction.

In some aspects, the techniques described herein relate to a platform, wherein the autoencoder architecture performs one or more of: blind deconvolution to identify portions of the regions of interest that define, undamaged tissue samples, unaltered tissue samples, or healthy tissue baselines.

In some aspects, the techniques described herein relate to a platform, wherein the portions of the regions of interest are defined by one or more of: a set of pixels in an MRI image, voxels in a 3D image, or segmented anatomical regions.

In some aspects, the techniques described herein relate to a platform, wherein the range of healing scores includes one or more of: not healing, poor healing, average healing, and good healing, binary healing classification, continuous scoring from 0-100.

In some aspects, the techniques described herein relate to a platform, wherein the predictive neural network further predicts one or more of: changes over time of a healing score for a patient uses, temporal modeling, longitudinal analysis, time-series prediction.

In some aspects, the techniques described herein relate to a platform, wherein the physics model of surgical implant effects incorporates one or more of: biomechanical properties, tissue-implant interaction models, inflammatory response modeling.

In some aspects, the techniques described herein relate to a platform, wherein the representativeness and uncertainty measurement techniques include one or more of: statistical sampling methods, confidence interval calculations, Bayesian uncertainty quantification.

In some aspects, the techniques described herein relate to a platform, wherein the images include one or more of: MRI images, CT scan images, ultrasound images, or X-ray images.

In some aspects, the techniques described herein relate to a platform, wherein the images are captured, during surgery, post-surgery, and/or pre-surgery.

In some aspects, the techniques described herein relate to a platform, wherein the implant is one or more of: a bio-scaffold tissue implant, an orthopedic implant, a cardiac implant, or a neural implant.

In some aspects, the techniques described herein relate to a platform, wherein the healing score is further based on patient or surgery attributes including one or more of time period for healing, patient age, comorbidities, or patient health condition.

In some aspects, the techniques described herein relate to a platform, wherein the healing score guides one or more of: post-surgical therapeutic direction, surgical planning, or implant optimization.

In some aspects, the techniques described herein relate to a platform, wherein the healing score provides feedback to one or more of: implant design, implant chemistries, or implant methods.

In some aspects, the techniques described herein relate to a platform, further including a set of artificial intelligence services trained to facilitate detecting and visualizing one or more of: edge effects of tissue, tumor edge visualization, or select anatomy detection.

In some aspects, the techniques described herein relate to a platform, further including a set of artificial intelligence services trained to detect select tissue including one or more of: tumor tissue, scar tissue, or necrotic tissue and to predict a corresponding impact on the healing score.

In some aspects, the techniques described herein relate to a platform, wherein the impact on the healing score represents a one or more of: a malady score, a complication indicator, or a risk assessment metric.

In some aspects, the techniques described herein relate to a platform, wherein the healing score is further based on supplemental data representative of one or more of: chemistry, optics, genetics, non-visible tissue and related anatomy including nerves, blood vessels, or anatomical structures.

In some aspects, the techniques described herein relate to a platform, wherein the predictive neural network is further configured with one or more of: large language model features and structures, natural language processing capabilities, or multimodal learning.

In some aspects, the techniques described herein relate to a platform, wherein the large language model features are trained from one or more of: the supplemental data and the images of the surgery-patient implant sites, medical literature, clinical guidelines or sources of medical science and practice to develop a medical anomaly-aware vocabulary.

In some aspects, the techniques described herein relate to a platform, wherein a large-language model neural network system processes the medical anomaly-aware vocabulary and the images of the surgery-patient implant sites to facilitate one or more of: a description of the implant sites with respect to the healing score, automated reporting, or clinical decision support.

In some aspects, the techniques described herein relate to a platform, wherein the set of artificial intelligence services provides a set of recommendations for at least one of: surgical actions to improve post-operative healing, avoid surgical errors, reduce a likelihood of requiring re-operation.

In some aspects, the techniques described herein relate to a platform, wherein the predictive neural network processes the supplemental data to predict anatomical changes, detect anatomical changes, and/or monitor tissue evolution.

In some aspects, the techniques described herein relate to predicting tissue changes post-surgery with a pair of neural networks

In some aspects, the techniques described herein relate to a platform for predicting changes in tissue post-surgery having a first neural network having an autoencoder architecture for generating a training set of tissue regions of interest of a set of images; and a second neural network trained with the training set to predict a healing score representative of changes in the regions of interest of a set of post-surgery patient tissue images, the second neural network operating a physics model of surgical implant effects, the physics model using representativeness and uncertainty measurement techniques.

In some aspects, the techniques described herein relate to a platform, wherein the first neural network autoencoder architecture uses one or more of: convolutional layers, recurrent layers, transformer architecture.

In some aspects, the techniques described herein relate to a platform, wherein the second neural network is trained with the training set using one or more of: supervised learning, semi-supervised learning, transfer learning.

In some aspects, the techniques described herein relate to a platform, wherein the physics model operates using one or more of: finite element analysis, computational fluid dynamics, biomechanical simulation.

In some aspects, the techniques described herein relate to a platform, wherein the representativeness measurement techniques include one or more of: manifold learning, clustering analysis, statistical sampling.

In some aspects, the techniques described herein relate to a platform, wherein the uncertainty measurement techniques include one or more of: entropy calculation, variance estimation, confidence scoring.

In some aspects, the techniques described herein relate to a platform, wherein the second neural network includes one or more of: graph convolutional layers, fully connected layers, attention mechanisms.

In some aspects, the techniques described herein relate to a platform, wherein the images include one or more of: MRI images, CT scan images, ultrasound images, X-ray images.

In some aspects, the techniques described herein relate to a platform, wherein the images are captured, during surgery, post-surgery, and/or pre-surgery.

In some aspects, the techniques described herein relate to a platform, wherein the implant is one or more of: a bio-scaffold tissue implant, an orthopedic implant, a cardiac implant, a neural implant.

In some aspects, the techniques described herein relate to a platform, wherein the healing score is further based on patient or surgery attributes including one or more of time period for healing, patient age, comorbidities, or patient health condition.

In some aspects, the techniques described herein relate to a platform, wherein the healing score guide one or more of: post-surgical therapeutic direction, surgical planning, or implant optimization.

In some aspects, the techniques described herein relate to a platform, wherein the healing score provides feedback to one or more of: implant design, implant chemistries, or implant methods.

In some aspects, the techniques described herein relate to a platform, further including a set of artificial intelligence services trained to facilitate detecting and visualizing one or more of: edge effects of tissue, tumor edge visualization, or select anatomy detection.

In some aspects, the techniques described herein relate to a platform, further including a set of artificial intelligence services trained to detect select tissue including one or more of: tumor tissue, scar tissue, or necrotic tissue and to predict a corresponding impact on the healing score.

In some aspects, the techniques described herein relate to a platform, wherein the impact on the healing score represents one or more of: a malady score, a complication indicator, a risk assessment metric.

In some aspects, the techniques described herein relate to a platform, wherein the healing score is further based on supplemental data representative of one or more of: chemistry, optics, genetics, non-visible tissue and related anatomy including nerves, blood vessels, or anatomical structures.

In some aspects, the techniques described herein relate to a platform, wherein the predictive neural network is further configured with one or more of: large language model features and structures, natural language processing capabilities, or multimodal learning.

In some aspects, the techniques described herein relate to a platform, wherein the large language model features are trained from one or more of: the supplemental data and the images of the surgery-patient implant sites, medical literature, clinical guidelines and sources of medical science and practice to develop a medical anomaly-aware vocabulary.

In some aspects, the techniques described herein relate to a platform, wherein a large-language model neural network system processes the medical anomaly-aware vocabulary with the images of the surgery-patient implant sites to facilitate one or more of: a description of the implant sites with respect to the healing score, automated reporting, or clinical decision support.

In some aspects, the techniques described herein relate to a platform, wherein the set of artificial intelligence services provides a set of recommendations for at least one of surgical actions to improve post-operative healing, avoid surgical errors, or reduce a likelihood of requiring re-operation.

In some aspects, the techniques described herein relate to a platform, wherein the predictive neural network processes the supplemental data to predict anatomical changes, detect anatomical changes, and/or monitor tissue evolution.

In some aspects, the techniques described herein relate to improving accuracy of healing score prediction

In some aspects, the techniques described herein relate to a platform for improving accuracy of predicting a healing score of tissue in a post-surgery implant region of a patient, the platform having a facility performing weighted incremental dictionary learning on images of tissue regions of interest that distinguishes among representative samples and uncertain samples to prepare an incremental training set for a neural network configured to predict a healing score for a set of post-surgery patient tissue images.

In some aspects, the techniques described herein relate to a platform, wherein the weighted incremental dictionary learning uses one or more of: L1 regularization, L2 regularization, or clastic net regularization.

In some aspects, the techniques described herein relate to a platform, wherein the facility performing weighted incremental dictionary learning implements one or more of: batch processing, online learning, or mini-batch optimization.

In some aspects, the techniques described herein relate to a platform, wherein the representative samples are identified using one or more of: clustering algorithms, manifold projection, or statistical analysis.

In some aspects, the techniques described herein relate to a platform, wherein the uncertain samples are identified using one or more of: entropy measures, prediction confidence, or variance analysis.

In some aspects, the techniques described herein relate to a platform, wherein the incremental training set is updated periodically, continuously, and/or based on performance metrics.

In some aspects, the techniques described herein relate to a platform, wherein the neural network configured to predict a healing score uses one or more of: a deep learning architecture, ensemble methods, or hybrid AI approaches.

In some aspects, the techniques described herein relate to a platform, wherein the predictive neural network is further configured with one or more of: large language model features and structures, natural language processing capabilities, or multimodal learning.

In some aspects, the techniques described herein relate to a platform, wherein the large language model features are trained from one or more of: the supplemental data and the images of the surgery-patient implant sites, medical literature, clinical guidelines and sources of medical science and practice to develop a medical anomaly-aware vocabulary.

In some aspects, the techniques described herein relate to a platform, wherein a large-language model neural network system processes the medical anomaly-aware vocabulary with the images of the surgery-patient implant sites to facilitate one or more of: a description of the implant sites with respect to the healing score, automated reporting, or clinical decision support.

In some aspects, the techniques described herein relate to a platform, wherein the set of artificial intelligence services provides a set of recommendations for at least one of surgical actions to improve post-operative healing, avoid surgical errors, or reduce a likelihood of requiring re-operation.

In some aspects, the techniques described herein relate to a platform, wherein the predictive neural network processes the supplemental data to predict anatomical changes, detect anatomical changes, and/or monitor tissue evolution.

In some aspects, the techniques described herein relate to active Learning System for

### Medical Image Labeling

In some aspects, the techniques described herein relate to a system for generating labeled training data for medical image analysis including: a weighted incremental dictionary learning module that processes unlabeled medical images to distinguish between representative samples and uncertain samples using geometric simple linear iterative clustering (SLIC) with an elliptic kernel; an uncertainty measurement component that calculates entropy values for sample predictions according to the formula H(x)=−Σp(yj|x) log (p(yj|x)) where p(yj|x) represents the probability that sample x belongs to class j; a representativeness measurement component that projects samples to a Grassman manifold to determine sample representativeness; and an active learning controller that iteratively selects most representative samples while rejecting most uncertain samples to generate an optimized labeled training dataset for medical image classification.

In some aspects, the techniques described herein relate to a system, wherein the medical images include, MRI images, CT scan images, ultrasound images.

In some aspects, the techniques described herein relate to a system, wherein the medical images are captured during surgery, post-surgery, and/or pre-surgery.

In some aspects, the techniques described herein relate to a system, wherein the system processes images of one or more of: bio-scaffold tissue implants, orthopedic implants, or cardiac implants.

In some aspects, the techniques described herein relate to a system, further including a healing score output module that classifies tissue healing into categories of one or more of: not healing, poor healing, average healing, good healing, binary healing/non-healing classification, or continuous healing score from 0-100.

In some aspects, the techniques described herein relate to a system, wherein the system incorporates patient attributes including one or more of: time period for healing, patient age, comorbidities, or patient health condition.

In some aspects, the techniques described herein relate to a system, wherein the system provides feedback to implant design, implant chemistries, and/or implant methods.

In some aspects, the techniques described herein relate to a system, wherein the system guides one or more of: post-surgical therapeutic direction, surgical planning, or implant selection.

In some aspects, the techniques described herein relate to a system, further including artificial intelligence services trained to detect one or more of: tumor tissue, scar tissue, or anatomical structures.

In some aspects, the techniques described herein relate to a system, wherein the artificial intelligence services provide recommendations for one or more of: surgical actions to improve post-operative healing, avoiding surgical errors, or reducing likelihood of requiring re-operation.

In some aspects, the techniques described herein relate to a system, wherein the system processes supplemental data representative of one or more of: chemistry, optics, genetics, or anatomical structures including nerves and blood vessels.

In some aspects, the techniques described herein relate to a system, wherein the geometric simple linear iterative clustering uses an elliptic kernel with one or more of: adaptive bandwidth selection, fixed bandwidth parameters, or multi-scale clustering.

In some aspects, the techniques described herein relate to a system, wherein the Grassman manifold projection uses one or more of: principal angles measurement, geodesic distance calculation, or subspace clustering.

In some aspects, the techniques described herein relate to a system, wherein the weighted incremental dictionary learning optimizes an objective function using one or more of: L1 regularization, L2 regularization, or elastic net regularization.

In some aspects, the techniques described herein relate to a system, wherein the uncertainty measurement component calculates entropy values with one or more of: normalized probability distributions, weighted probability distributions, or temperature-scaled probability distributions.

In some aspects, the techniques described herein relate to a system, wherein the active learning controller implements one or more of: batch selection strategies, sequential selection strategies, or hybrid selection strategies.

In some aspects, the techniques described herein relate to wasserstein GAN Medical Image Synthesis System

In some aspects, the techniques described herein relate to a medical image synthesis platform including: a Wasserstein Generative Adversarial Network (WGAN) having a generator network and a discriminator network, wherein the generator produces synthetic medical tissue images from a latent space and the discriminator evaluates generated samples against real medical images using Wasserstein distance; a penalty term component that adds a gradient penalty to the discriminator loss function according to Dloss=Ezpz[D(G(z))]−ExPdata(x)[D(x)]+λEx˜[∥∇D(x)∥2−1]² to prevent vanishing or exploding gradients; a convergence detection module that monitors when the generator network produces the same probability density function as the discriminator network using Kullback-Leibler divergence comparison; and a synthetic dataset output module that provides generated medical tissue images for training downstream classification systems.

In some aspects, the techniques described herein relate to a system, wherein the medical images include, MRI images, CT scan images, ultrasound images.

In some aspects, the techniques described herein relate to a system, wherein the medical images are captured during surgery, post-surgery, and/or pre-surgery.

In some aspects, the techniques described herein relate to a system, wherein the system processes images of one or more of: bio-scaffold tissue implants, orthopedic implants, or cardiac implants.

In some aspects, the techniques described herein relate to a system, further including a healing score output module that classifies tissue healing into categories of one or more of: not healing, poor healing, average healing, good healing, binary healing/non-healing classification, or continuous healing score from 0-100.

In some aspects, the techniques described herein relate to a system, wherein the system incorporates patient attributes including one or more of: time period for healing, patient age, comorbidities, or patient health condition.

In some aspects, the techniques described herein relate to a system, wherein the system provides feedback to implant design, implant chemistries, and/or implant methods.

In some aspects, the techniques described herein relate to a system, wherein the system guides one or more of: post-surgical therapeutic direction, surgical planning, or implant selection.

In some aspects, the techniques described herein relate to a system, further including artificial intelligence services trained to detect one or more of: tumor tissue, scar tissue, or anatomical structures.

In some aspects, the techniques described herein relate to a system, wherein the artificial intelligence services provide recommendations for one or more of: surgical actions to improve post-operative healing, avoiding surgical errors, or reducing likelihood of requiring re-operation.

In some aspects, the techniques described herein relate to a system, wherein the Wasserstein distance calculation uses one or more of: 1-Wasserstein distance, 2-Wasserstein distance, optimal transport formulation.

In some aspects, the techniques described herein relate to a system, wherein the latent space includes one or more of: random Gaussian noise, sparse representation of training data, or learned latent embeddings.

In some aspects, the techniques described herein relate to a system, wherein the generator network uses one or more of: multilayer perceptron architecture, convolutional neural network architecture, or transformer architecture.

In some aspects, the techniques described herein relate to a system, wherein the discriminator network implements one or more of: spectral normalization, batch normalization, or layer normalization.

In some aspects, the techniques described herein relate to a system, wherein the gradient penalty coefficient λ is one or more of: adaptively adjusted during training, fixed at a predetermined value, or scheduled according to training epochs.

In some aspects, the techniques described herein relate to a system, wherein the convergence detection module monitors one or more of: Kullback-Leibler divergence, Jensen-Shannon divergence, or Wasserstein distance convergence.

In some aspects, the techniques described herein relate to multi-Modal Medical Data Integration Platform

In some aspects, the techniques described herein relate to a platform for integrating diverse medical data sources for post-surgical assessment including: a supplemental data processing module that receives and processes chemistry data, optics data, genetics data, and anatomical structure data including nerves, blood vessels, and anatomical structures; a large language model neural network system trained from medical science and practice sources to develop a medical anomaly-aware vocabulary; a multi-modal fusion component that combines the supplemental data with medical images of surgery-patient implant sites using the medical anomaly-aware vocabulary; a natural language generation module that processes the medical anomaly-aware vocabulary with the images to generate textual descriptions of implant sites; and an integrated assessment output that provides comprehensive evaluation results incorporating both imaging and supplemental data sources.

In some aspects, the techniques described herein relate to a system, wherein the medical images include, MRI images, CT scan images, ultrasound images.

In some aspects, the techniques described herein relate to a system, wherein the medical images are captured during surgery, post-surgery, and/or pre-surgery.

In some aspects, the techniques described herein relate to a system, wherein the system processes images of one or more of: bio-scaffold tissue implants, orthopedic implants, or cardiac implants.

In some aspects, the techniques described herein relate to a system, further including a healing score output module that classifies tissue healing into categories of one or more of: not healing, poor healing, average healing, good healing, binary healing/non-healing classification, or continuous healing score from 0-100.

In some aspects, the techniques described herein relate to a system, wherein the system incorporates patient attributes including one or more of: time period for healing, patient age, comorbidities, or patient health condition.

In some aspects, the techniques described herein relate to a system, wherein the system provides feedback to implant design, implant chemistries, and/or implant methods.

In some aspects, the techniques described herein relate to a system, wherein the system guides one or more of: post-surgical therapeutic direction, surgical planning, or implant selection.

In some aspects, the techniques described herein relate to a system, further including artificial intelligence services trained to detect one or more of: tumor tissue, scar tissue, or anatomical structures.

In some aspects, the techniques described herein relate to a system, wherein the artificial intelligence services provide recommendations for one or more of: surgical actions to improve post-operative healing, avoiding surgical errors, or reducing likelihood of requiring re-operation.

In some aspects, the techniques described herein relate to a system, wherein the system processes supplemental data representative of one or more of: chemistry, optics, genetics, or anatomical structures including nerves and blood vessels.

In some aspects, the techniques described herein relate to a system, wherein the large language model neural network system is trained using one or more of: transformer architecture, BERT-based models, or GPT-based models.

In some aspects, the techniques described herein relate to a system, wherein the medical anomaly-aware vocabulary includes one or more of: anatomical terminology, pathological descriptors, or surgical procedure terminology.

In some aspects, the techniques described herein relate to a system, wherein the multi-modal fusion component uses one or more of: attention mechanisms, concatenation strategies, or cross-modal alignment.

In some aspects, the techniques described herein relate to a system, wherein the natural language generation module produces one or more of: structured medical reports, natural language descriptions, or standardized assessment forms.

In some aspects, the techniques described herein relate to a system, wherein the supplemental data processing module normalizes data using one or more of: z-score normalization, min-max scaling, or robust scaling.

In some aspects, the techniques described herein relate to graph-Based Medical Image

### Classification System

In some aspects, the techniques described herein relate to a graph-based classification system for medical image analysis including: an adjacency matrix construction module that converts medical image pixel relationships into graph edge representations for an undirected graph structure; a Graph Convolutional Network (GCN) classifier having multiple GCN layers that perform convolution operations on non-Euclidean graph structures to handle complex medical image topologies; a graph embedding generator that creates spatial graph embeddings from medical image data and integrates physician-provided information as graph node features; an adaptive pixel-neighborhood selection component that dynamically determines optimal pixel relationships for graph construction; and a classification output module that processes the graph embeddings through the GCN to generate medical image classification results.

In some aspects, the techniques described herein relate to a system, wherein the medical images include, MRI images, CT scan images, ultrasound images.

In some aspects, the techniques described herein relate to a system, wherein the medical images are captured during surgery, post-surgery, and/or pre-surgery.

In some aspects, the techniques described herein relate to a system, wherein the system processes images of one or more of: bio-scaffold tissue implants, orthopedic implants, or cardiac implants.

In some aspects, the techniques described herein relate to a system, further including a healing score output module that classifies tissue healing into categories of one or more of: not healing, poor healing, average healing, good healing, binary healing/non-healing classification, or continuous healing score from 0-100.

In some aspects, the techniques described herein relate to a system, wherein the system incorporates patient attributes including one or more of: time period for healing, patient age, comorbidities, or patient health condition.

In some aspects, the techniques described herein relate to a system, wherein the system provides feedback to implant design, implant chemistries, and/or implant methods.

In some aspects, the techniques described herein relate to a system, wherein the system guides one or more of: post-surgical therapeutic direction, surgical planning, or implant selection.

In some aspects, the techniques described herein relate to a system, further including artificial intelligence services trained to detect one or more of: tumor tissue, scar tissue, or anatomical structures.

In some aspects, the techniques described herein relate to a system, wherein the artificial intelligence services provide recommendations for one or more of: surgical actions to improve post-operative healing, avoiding surgical errors, or reducing likelihood of requiring re-operation.

In some aspects, the techniques described herein relate to a system, wherein the system processes supplemental data representative of one or more of: chemistry, optics, genetics, or anatomical structures including nerves and blood vessels.

In some aspects, the techniques described herein relate to a system, wherein the Graph Convolutional Network includes one or more of: four GCN layers with 64 units each, variable number of layers, adaptive layer sizing.

In some aspects, the techniques described herein relate to a system, wherein the GCN layers use one or more of: ReLU activation, sigmoid activation, tanh activation.

In some aspects, the techniques described herein relate to a system, wherein the adjacency matrix construction uses one or more of: k-nearest neighbor connectivity, radius-based connectivity, learned connectivity patterns.

In some aspects, the techniques described herein relate to a system, wherein the adaptive pixel-neighborhood selection implements one or more of: dynamic radius adjustment, connectivity pruning, multi-scale neighborhood analysis.

In some aspects, the techniques described herein relate to a system, wherein the graph embeddings incorporate one or more of: spatial coordinates, intensity values, texture features.

In some aspects, the techniques described herein relate to a system, further including a global pooling layer that applies one or more of: global average pooling, global max pooling, attention-based pooling.

The various components may include a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that include electronic circuits process computer logic instructions capable of providing digital and/or analog signals for performing various functions as described herein. The various functions may further be embodied and physically saved as any of data structures, data paths, data objects, data object models, object files, database components. For example, the data objects could include a digital packet of structured data. Example data structures may include any of an array, tuple, map, union, variant, set, graph, tree, node, and an object, which may be stored and retrieved by computer memory and may be managed by processors, compilers, and other computer hardware components. The data paths may be part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be physical locations in computer memory and may be a variable, a data structure, or a function. Some examples of the modules include relational databases (e.g., such as Oracle® relational databases), and the data objects may be a table or column, for example. Other examples include specialized objects, distributed objects, object-oriented programming objects, and semantic web objects. The data object models may be an application programming interface for creating HyperText Markup Language (HTML) and Extensible Markup Language (XML) electronic documents. The models may be any of a tree, graph, container, list, map, queue, set, stack, and variations thereof, according to some examples. The data object files may be created by compilers and assemblers and contain generated binary code and data for a source file. The database components may include any of tables, indexes, views, stored procedures, and triggers.

In an example, the embodiments herein may provide a computer program product configured to include a pre-configured set of instructions, which when performed, may result in actions as stated in conjunction with various figures herein. In an example, the pre-configured set of instructions may be stored on a tangible non-transitory computer readable medium. In an example, the tangible non-transitory computer readable medium may be configured to include the set of instructions, which when performed by a device, may cause the device to perform acts similar to the ones described here.

The embodiments herein may also include tangible and/or non-transitory computer-readable storage media for carrying or having computer-executable instructions or data structures stored thereon. Such non-transitory computer readable storage media may be any available media that may be accessed by a general purpose or special purpose computer, including the functional design of any special purpose processor as discussed above.

By way of example, and not limitation, such non-transitory computer-readable media may include RAM, ROM, EEPROM, CD-ROM or other optical disk storage, magnetic disk storage or other magnetic storage devices, or any other medium which may be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above may also be included within the scope of the computer-readable media.

Computer-executable instructions include, for example, instructions and data which cause a special purpose computer or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language and stored in a computer storage medium, such as a disk, tape, physical hard drive, or virtual hard drive such as in a storage access network. If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips may be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product may be any product that includes integrated circuit chips, ranging from toys and other low-end applications to advanced computer products having a display, a keyboard or other input device, and a central processor.

Furthermore, the embodiments herein may take the form of a computer program product accessible from a computer-usable or computer-readable medium providing program code for use by or in connection with a computer or any instruction execution system. For the purposes of this description, a computer-usable or computer readable medium may be any apparatus that may comprise, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium may include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the present invention.

What is claimed is:

1. A computer-implemented platform for predicting changes in tissue post-surgery, the platform operating as a post-surgical imaging analysis system configured to process acquired medical images and comprising:
a training set of images of tissue regions of interest, the training set prepared from a set of tissue images by execution of a neural network having an autoencoder architecture that processes pixel-level image data to identify regions of interest representing undamaged or unaltered tissue;
a physics model of surgical implant effects that uses representativeness and uncertainty measurement techniques to compute, from image-derived feature data, quantitative measures of tissue-implant interaction behavior and predict post-surgery changes to surgery-patient implant sites; and
a healing score predictive neural network executed by one or more processors and operating on a structured representation of the tissue regions of interest, the predictive neural network classifying images of the surgery-patient implant sites against a range of healing scores indicative of a degree of healing, the predictive neural network further predicting changes over time of a healing score for a patient.

2. The platform of claim 1, wherein the healing score is further based on patient or surgery attributes including one or more of time period for healing, patient age, comorbidities, and patient health condition.

3. The platform of claim 1, wherein the implant is a bio-scaffold tissue implant.

4. The platform of claim 1, wherein the physics model filters training samples by rejecting uncertain samples and prioritizing representative samples, thereby reducing training instability and improving convergence accuracy of the predictive neural network relative to random sample selection.

5. The platform of claim 1, wherein the predictive neural network predicts changes over time of a healing score for a patient by applying longitudinal time-series modeling across multiple post-surgical implant image acquisition events.

6. The platform of claim 1, wherein the autoencoder architecture performs blind deconvolution when generating the regions of interest.

7. The platform of claim 1, wherein the autoencoder architecture performs blind deconvolution to identify portions of the regions of interest that define undamaged/unaltered tissue samples.

8-9. (canceled)

10. The platform of claim 1, wherein the healing score guides post-surgical therapeutic direction.

11. The platform of claim 1, wherein the healing score provides feedback to implant design, implant chemistries, and implant methods.

12. The platform of claim 1 further including a set of artificial intelligence services trained to facilitate detecting and visualizing edge effects of tissue, including one or more of tumor edge visualization, or select anatomy detection.

13. The platform of claim 1 further including a set of artificial intelligence services trained to detect select tissue including tumor tissue, scar tissue and to predict a corresponding impact on the healing score.

14-15. (canceled)

16. The platform of claim 13, wherein the set of artificial intelligence services provides a set of recommendations for at least one of surgical actions to improve post-operative healing, avoid surgical errors, and reduce a likelihood of requiring re-operation.

17. The platform of claim 1, wherein the healing score is further based on supplemental data representative of chemistry, optics, genetics, non-visible tissue and related anatomy including nerves, blood vessels, anatomical structures.

18. The platform of claim 17, wherein the predictive neural network processes the supplemental data to predict and/or detect anatomical changes.

19. The platform of claim 18, wherein the predictive neural network is further configured with large language model features and structures trained from the supplemental data and the images of the surgery-patient implant sites and sources of medical science and practice to develop a medical anomaly-aware vocabulary.

20. The platform of claim 19, wherein a large-language model neural network system processes the medical anomaly-aware vocabulary with the images of the surgery-patient implant sites to facilitate a description of the implant sites with respect to the healing score.

21-143. (canceled)

144. A computer-implemented platform for predicting changes in tissue post-surgery, comprising:
one or more processors and non-transitory memory storing instructions that, when executed by the one or more processors, cause the platform to:
generate a training set of tissue regions of interest by applying an autoencoder neural network to pixel-level medical image data to identify regions corresponding to undamaged or unaltered tissue;
generate image-derived feature data from the tissue regions of interest;
execute a physics-informed model of surgical implant effects that computes representativeness measures and uncertainty measures from the image-derived feature data, the representativeness measures characterizing tissue-implant interaction behavior and the uncertainty measures characterizing prediction confidence;
select training samples for predictive modeling based at least in part on the representativeness measures and the uncertainty measures, thereby promoting neural network convergence stability during training; and
execute a trained predictive neural network operating on a structured representation of the selected tissue regions of interest to classify surgery-patient implant site images into a range of healing scores and to predict temporal changes in the healing scores for a patient.

145. The computer-implemented platform of claim 144, wherein to select training samples for predictive modeling is based at least in part on the representativeness measures and the uncertainty measures, the selecting constraining training of the predictive neural network to promote convergence stability during model training.

146. The computer-implemented platform of claim 144, wherein the autoencoder neural network performs one or more of: blind deconvolution when generating the regions of interest, feature extraction, or dimensionality reduction.

147. The computer-implemented platform of claim 144, wherein the autoencoder neural network performs one or more of: blind deconvolution to identify portions of the regions of interest that define, undamaged tissue samples, unaltered tissue samples, or healthy tissue baselines.
